(19) United States
(12) Patent Application Publication
(10) Pub. No.: US 2014/0358522 A1
(43) Pub. Date: Dec. 4, 2014

(54) INFORMATION SEARCH APPARATUS AND INFORMATION SEARCH METHOD

(71) Applicant: FUJITSU LIMITED, Kawasaki-shi (JP)

(72) Inventors: Seiji Okura, Meguro (JP); Akira Ushioda, Taito (JP)

(73) Assignee: FUJITSU LIMITED, Kawasaki-shi (JP)

(21) Appl. No.: 14/286,434

(22) Filed: May 23, 2014

(30) Foreign Application Priority Data
Jun. 4, 2013 (JP) 2013-118248

(51) Int. Cl. G06F 17/30

(52) U.S. Cl. CPC G06F 17/30654
USPC 704/9

(57) ABSTRACT

A processor of an information search apparatus receives an input of information that includes a plurality of search words. The processor separates two search words from the received information. The processor searches for and extracts, from a storage unit, two words that correspond to the two search words and semantic information of the two words, the storage unit storing a plurality of words included in a search target sentence and semantic information in association with the search target sentence, the semantic information stored in the storage unit indicating a relationship established within the search target sentence between the plurality of words and another word. An output unit outputs the extracted semantic information. This allows an intended search result to be obtained efficiently.

### CROSS-REFERENCE TO RELATED APPLICATION

This application is based upon and claims the benefit of priority of the prior Japanese Patent Application No. 2013-118248, filed on Jun. 4, 2013, the entire contents of which are incorporated herein by reference.

### FIELD

The embodiments discussed herein are related to an information search apparatus and an information search method.

### BACKGROUND

A technology is known wherein, when, for example, some information needs to be obtained from the internet, a keyword is entered at a search site to extract documents that include the entered keyword. Various technologies are known regarding language processing for performing such a keyword search. (See, for example, non-patent documents 1-3.)

Non-patent document 1: “Natural Language Understanding”, co-edited by Hozumi TANAKA and Junichiro TSUJII, Ohmsha, Ltd, 1988

Non-patent document 2: “Guide to Natural Language Processing”, by Steven Bird, Ewan Klein, and Edward Loper, translated by Masato HAGIWARA, Takahiro NAKAYAMA, and Takaaki MIZUNO, O'Reilly Japan, 2010

Non-patent document 3: “Natural Language Processing for Japanese Language Based on Python”, [online], Internet (http://nltk.googlecode.com/svn/trunk/doc/book-jp/ch12.ht ml), by Steven Bird, Ewan Klein, and Edward Loper, translated by Masato HAGIWARA, Takahiro NAKAYAMA, and Takaaki MIZUNO

### SUMMARY

According to an aspect of the embodiments, an information search apparatus includes a processor. The processor receives an input of information that includes a plurality of search words. The processor separates two search words from the received information and searches for and extracts, from a storage unit, two words corresponding to the two search words and semantic information of these two words, where the storage unit stores a plurality of words included in a search target sentence and semantic information in association with the search target sentence, and the semantic information stored in the storage unit indicates a relationship established in the search target sentence between the plurality of words and another word. An output unit is characterized in that it outputs the extracted semantic information.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating an exemplary configuration of an information search apparatus;

FIG. 2 illustrates an exemplary analysis of a sentence;

FIG. 3 illustrates an exemplary analysis of a sentence;

FIG. 4 illustrates an exemplary analysis of a sentence;

FIG. 5 illustrates exemplary character offsets and exemplary semantic marks;

FIG. 6 illustrates an exemplary index table;

FIG. 7 illustrates an exemplary evaluation-value table;

FIG. 8 is a flowchart illustrating a search process performed when a query is a sentence;

FIG. 9 illustrates an exemplary word table that includes words divided from a query;

FIG. 10 illustrates an exemplary dictionary table.

FIG. 11 illustrates exemplary search keys;

FIG. 12 illustrates an exemplary search result;

FIG. 13 illustrates an exemplary screen display indicating a search result;

FIG. 14 illustrates an example of a converted version of a table indicating a search result;

FIG. 15 illustrates an example of a converted version of a table indicating a search result;

FIG. 16 illustrates an example of a converted version of a table indicating a search result;

FIG. 17 illustrates an example of a converted version of a table indicating a search result;

FIG. 18 illustrates a selection example;

FIG. 19 is a flowchart illustrating a search process based on a keyword;

FIG. 20 is a flowchart illustrating an exemplary table-converting process;

FIG. 21 illustrates an exemplary screen display indicating a search result in accordance with variation 1;

FIG. 22 illustrates an exemplary screen display indicating a search result in accordance with variation 1;

FIG. 23 illustrates an exemplary screen display indicating a search result in accordance with variation 1;

FIG. 24 illustrates an exemplary screen display indicating a search result in accordance with variation 1;

FIG. 25 illustrates an exemplary screen display indicating a search result in accordance with variation 1;

FIG. 26 illustrates an exemplary screen display indicating a search result in accordance with variation 1;

FIG. 27 illustrates an exemplary analysis of a sentence in accordance with variation 2;

FIG. 28 illustrates an exemplary analysis of a sentence in accordance with variation 2;

FIG. 29 illustrates an exemplary analysis of a sentence in accordance with variation 2;

FIG. 30 illustrates exemplary character offsets and semantic marks in accordance with variation 2;

FIG. 31 illustrates a semantic analysis in accordance with variation 2;

FIG. 32 illustrates an exemplary dictionary table in accordance with variation 2;

FIG. 33 illustrates a semantic analysis in accordance with variation 2;

FIG. 34 illustrates an exemplary screen display indicating information in accordance with variation 2;

FIG. 35 illustrates an exemplary search result in accordance with variation 2; and

FIG. 36 illustrates an exemplary hardware configuration of a standard computer.

### DESCRIPTION OF EMBODIMENTS

In well-known keyword-based searches such as those described above, a query is used for each keyword, and hence a relationship between a plurality of keywords are not incorporated into search conditions. Accordingly, queries each provided for a keyword may include ambiguity, which may result in a meaning represented by the combinations of keywords being unable to be specified. In some cases, thus, in a keyword search, a search is not performed in accordance with a user's intentions. Documents that are not consistent with the user's intentions but include a keyword may be retrieved. That is, in some cases, a portion of an extracted document that hits a keyword is not information that the user needs. Hence, the user will spend time making a determination to extract useful information.

Preferred embodiments of the present invention will be explained with reference to accompanying drawings.

### First Embodiment

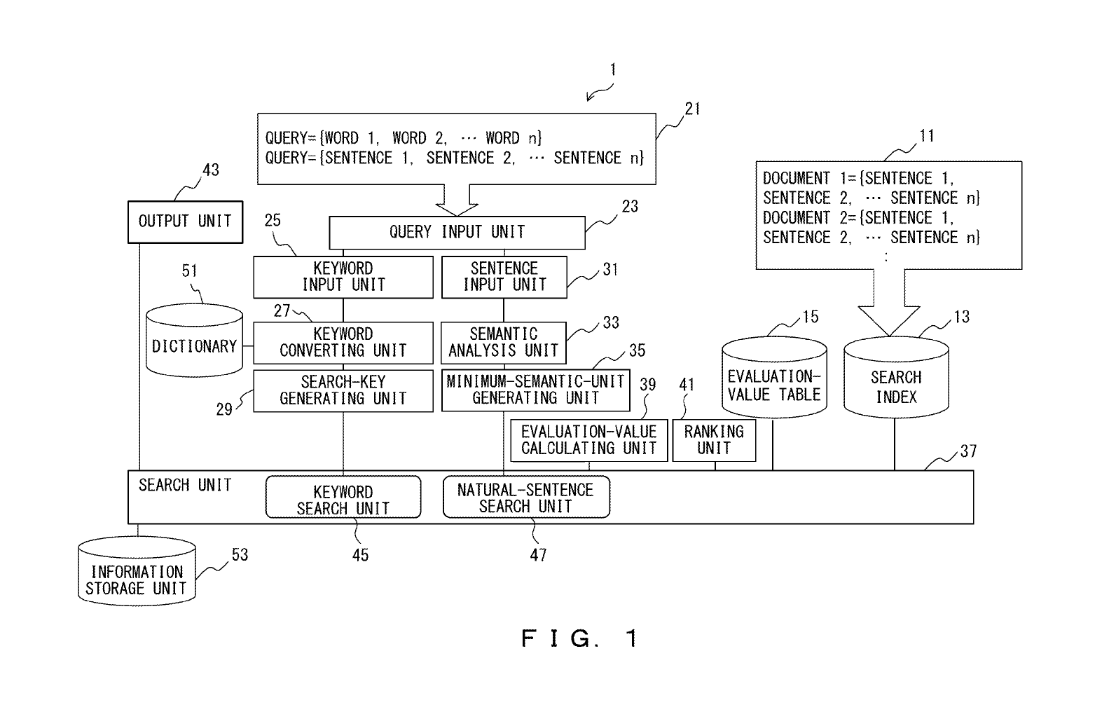

The following will describe an information processing apparatus 1 in accordance with a first embodiment with reference to the drawings. FIG. 1 is a block diagram illustrating an exemplary configuration of the information search apparatus 1. The information search apparatus 1 is a system that performs a search by inputting at least one word or sentence as a query. The information search apparatus 1 includes a target-document database (DB) 11, a search index 13, an evaluation-value table 15, an evaluation-value calculating unit 39, and a ranking unit 41. The information search apparatus 1 also includes a query input unit 23, a keyword input unit 25, a keyword converting unit 27, a search-key generating unit 29, a sentence-set input unit 31, a semantic analysis unit 33, a minimum-semantic-unit generating unit 35, a search unit 37, an output unit 43, a dictionary 51, and a storage unit 53. The search unit 37 includes a keyword search unit 45 and a natural-sentence search unit 47.

The search-target-document DB 11, the search index 13, and the evaluation-value table 15 are generated in a preparation process performed before a search is performed. The dictionary 51 is prepared in advance, but, depending on the situation, the dictionary 51 may have additional data added thereto or may be revisable. The search-target-document DB 11 is a database that stores search-target documents. For example, the documents stored in the search-target-document DB 11 are each preferably associated with identification information for identification thereof.

The search index 13 is a database that stores, for example, minimum semantic units and node positions within each sentence included in a search-target document. A minimum semantic unit indicates a relationship between two concepts within a sentence or indicates roles of the concepts. A node indicates a concept of a word within a sentence. In the preparation process performed in advance, semantic analyses of a plurality of search-target documents are performed, minimum semantic units are generated for each sentence within the documents, and a search index 13 is generated that includes, for example, the positions of nodes at a starting point and an end point and a character string length. The minimum semantic unit will be described hereinafter.

The evaluation-value table 15 stores evaluation values each related to a particular one of the minimum semantic units included in the search index 13. An evaluation value may be, for example, a value calculated according to a search count indicating the number of documents that include a minimum semantic unit. As an example, an idf value in the following formula, formula (1), may be used as an evaluation value.

idf=log (total number of documents/number of documents that include the minimum semantic unit) (formula 1)

The “total number of documents” is the total number of documents stored in the search-target-document DB 11. The “number of documents that include the minimum semantic unit” is the number of documents that include a minimum semantic unit for which an idf value is calculated from among the total number of documents. The idf value becomes higher as the number of search-target documents that include the minimum semantic unit becomes smaller. The evaluation value of a minimum semantic unit is preferably a value indicating the usability of the minimum semantic unit, but another value may be used. The evaluation-value calculating unit 39 calculates evaluation values.

As described above, to perform a search, a natural language sentence (hereinafter simply be referred to as a sentence) may be entered, or a word (hereinafter referred to as a keyword) may be entered. A query 21 is, for example, at least one keyword or sentence used to perform a search or the combination of a keyword and a sentence. The query input unit 23 receives the query 21 input via a user operation with, for example, a keyboard, mouse, or touch panel or input via a network and determines which of a sentence or a keyword the query 21 is. A determination on which of a sentence or a keyword a query is may be made in accordance with, for example, the presence/absence of a period or comma.

When the query 21 includes at least one keyword, the keyword input unit 25 receives a keyword character string of the query 21 and divides the keyword using a delimiter such as a space. For each of the divided keywords, the keyword converting unit 27 refers to the dictionary 51 to convert a word into a semantic mark. The dictionary 51 is information that associates a word with a semantic mark. A semantic mark indicates a meaning.

The search-key generating unit 29 generates two sets from semantic marks obtained from the converting and defines the two sets as search keys. The search unit 37 searches databases such as the search-target-document DB 11 and the search index 13 according to the search keys. Frequency information related to a minimum semantic unit that matches the search keys is also searched for. A search-result display unit displays a search result.

When the query 21 input to the query input unit 23 consists of sentences, the sentence-set input unit 31 receives and divides this query 21 into sentences using, for example, periods. The semantic analysis unit 33 performs, for example, a semantic analysis for each sentence of the query 21. The semantic analysis is output as a directed graph wherein the meanings of words (semantic marks) are nodes and the relationships between two semantic marks are arcs.

The minimum-semantic-unit generating unit 35 extracts, from a directed graph indicating the meaning of one sentence, a “minimum semantic unit” indicating a relationship between two semantic marks. For each arc, the minimum semantic unit includes a node from which the arc starts (starting point node), a node that the arc reaches (end point node), and an arc name. “NIL” indicates a situation in which neither a node from which the arc starts nor a node that the arc reaches is present.

When the query 21 is a keyword, the keyword search unit 45 of the search unit 37 searches the search index 13 using a search key generated from the query 21 as a condition. When the query 21 is a sentence, the natural-sentence search unit 47 searches the search index 13 using a minimum semantic unit generated from the query 21 as a condition. In a situation in which a plurality of minimum semantic units are search conditions, a search result is extracted when at least one of the search conditions is included. A document corresponding to a minimum semantic unit that matches a search is selected from the search index 13.

The evaluation-value calculating unit 39 refers to the evaluation-value table 15 and the search index 13 and calculates the evaluation value of a document that includes sentences extracted according to a minimum semantic unit that matches a search condition. The ranking unit 41 ranks extracted documents. That is, the ranking unit 41 sorts the documents using, as sort keys, the evaluation values of the documents calculated by the evaluation-value calculating unit 39.

As a result of the ranking, the output unit 43 outputs, for example, a search result provided by the keyword search unit 45, which will be described hereinafter. The forms of the output include, for example, displaying, printing, and transmitting. Extracted documents are arranged in, for example, order of usefulness or order of sorting and are presented to the user. Extracted documents are, for example, displayed. The dictionary 51 is information that stores a word and a semantic mark in association with each other. The storage unit 53 is, for example, a storage apparatus from which information can be read and to which information can be written on an as-needed basis for various processes.

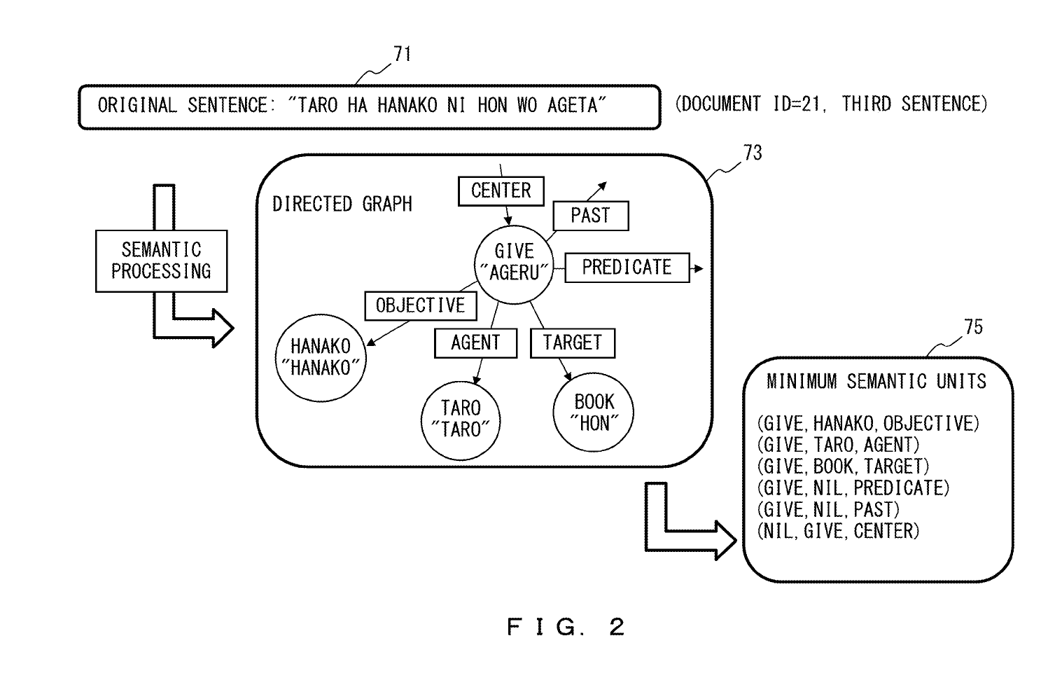

Next, with reference to FIGS. 2-6, descriptions will be given of a preparation process of generating the search-target-document DB 11, the search index 13, and the evaluation-value table 15. This process is similar to the process performed when a sentence is input as the query 21, and such a process may be performed by the sentence-set input unit 31, the semantic analysis unit 33, and the minimum-semantic-unit generating unit 35. Hence, descriptions will be given on the assumption that the process is performed using these elements. The preparation process may actually be performed by the information search apparatus before a search is performed. Alternatively, the preparation process may be performed by another apparatus that includes, for example, the sentence-set input unit 31, the semantic analysis unit 33, and the minimum-semantic-unit generating unit 35, and a search may be performed using the search-target-document DB 11, the search index 13, and the evaluation-value table 15, which have been generated by the apparatus that has performed the preparation process.

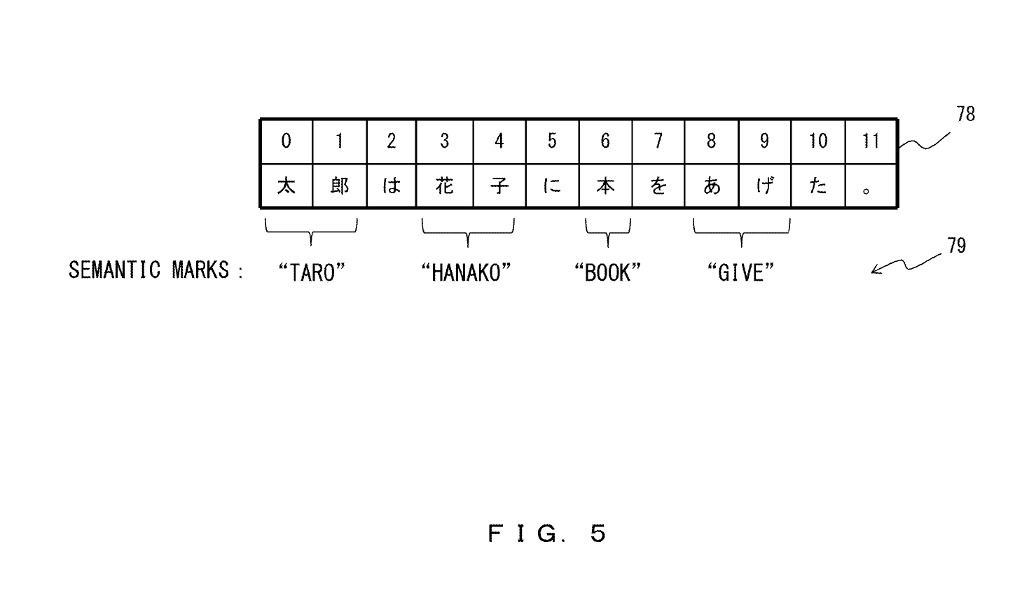

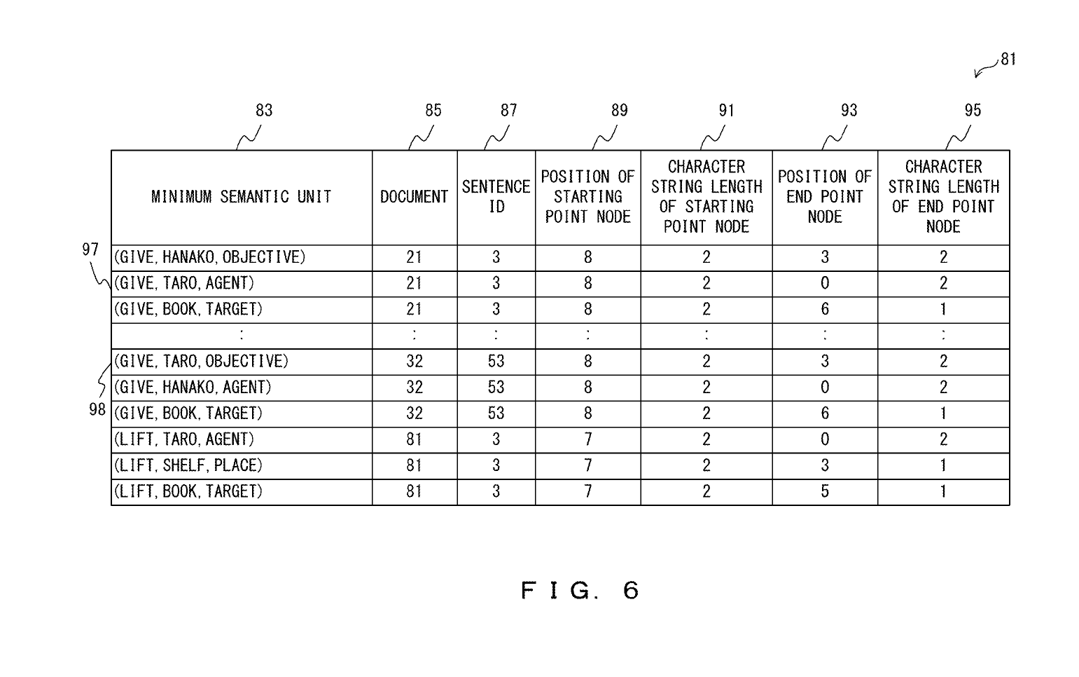

FIGS. 2-4 illustrate an exemplary analysis of a sentence. FIG. 5 illustrates exemplary character offsets and exemplary semantic marks. FIG. 6 illustrates an exemplary index table 81. When a document intended to be stored in the search-target-document DB 11 is input, the sentence-set input unit 31 divides the input document into sentences. The semantic analysis unit 33 performs a semantic analysis of each of the sentences obtained from the dividing. The semantic analysis unit 33 divides the sentences into words, which are defined as nodes, and analyzes relationships between the words so as to extract relationships between the nodes, and to extract starting point nodes, end point nodes, and node positions and character string lengths within the sentences. The minimum-semantic-unit generating unit 35 generates a minimum semantic unit according to the result of the semantic analysis.

In the example of FIG. 2, the semantic analysis unit 33 performs a semantic analysis of an input original sentence 71 “TARO HA HANAKO NI HON WO AGETA. (:Taro gave a book to Hanako.)” (Japanese written in Roman letters), and a directed graph 73 and minimum semantic units 75 are generated.

Next, descriptions will be given of a directed graph and a minimum semantic unit. A minimum semantic unit indicates a partial structure of a directed graph obtained as a result of a semantic analysis. A directed graph includes a node and an arc. In FIG. 2, the directed graph 73 indicates an exemplary directed graph, and the minimum semantic units 75 indicate exemplary minimum semantic units. The directed graph may be generated using, for example, any of the technologies described in non-patent documents 1-3.

A node indicates the concept (meaning) of a word within an input sentence. “AGERU(:give)”, “HON(:book)”, “TARO”, and “HANAKO” (Japanese written in Roman letters) are exemplary nodes. Each node has added thereto a mark indicating the concept thereof (referred to as a semantic mark). “GIVE”, “BOOK”, “TARO”, and “HANAKO” are exemplary semantic marks.

An arc indicates the relationship between nodes or the role of a node. An arc that is present between two nodes indicates the relationship between the two nodes. As an example, the arc from the node “GIVE” to the node “BOOK” in the figure is named “target”. This means that “BOOK” is a target of “GIVE”. Meanwhile, the arcs with no end point node indicate a role that the starting point node has. As an example, in the figure, one arc extending from the starting point node “GIVE” and having no end point node is named “past”. This means that “GIVE” is a role in the past. A node from which an arc extends is referred to as a starting point node, and a node to which an arc proceeds is referred to as an end point node.

In the generating of a minimum semantic unit, the semantic analysis unit 33 extracts arcs from the directed graph and performs processes of:

(a) when arcs each link two nodes, outputting (starting point node, end point node, arc name) as a minimum semantic unit for each arc;
(b) when a starting point node is not present, outputting (“NIL”, endpoint node, arc name) as a minimum semantic unit; and
(c) when an endpoint node is not present, outputting (starting point node, “NIL”, arc name) as a minimum semantic unit.

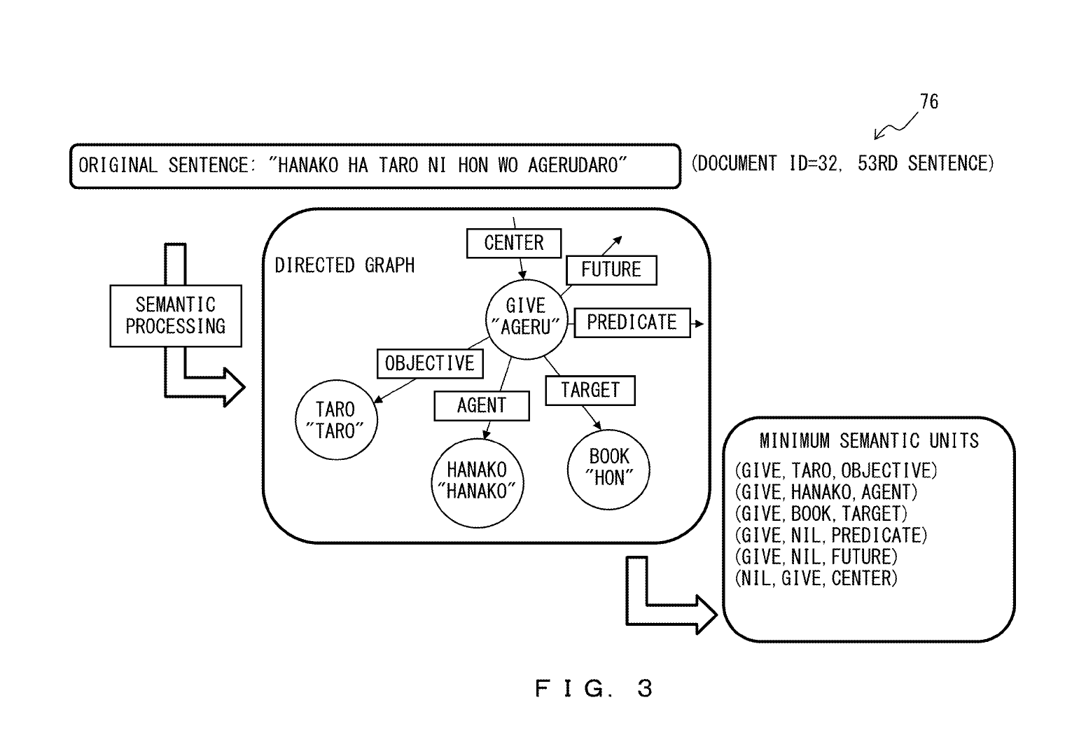

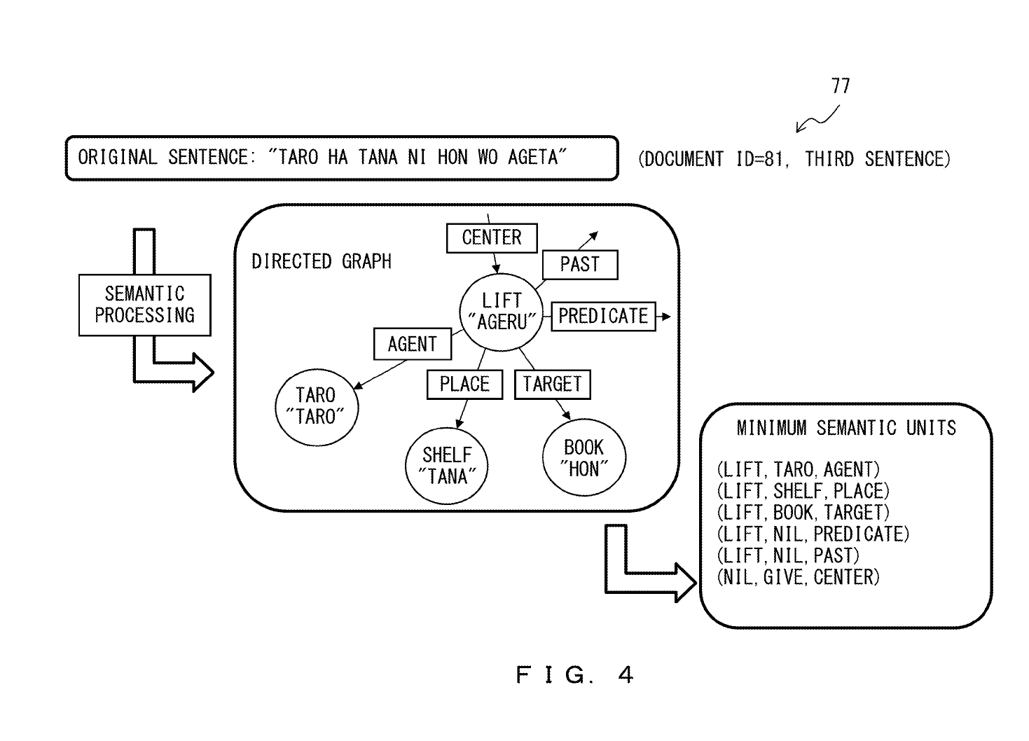

As described above, the minimum semantic units 75 are extracted from the input original sentence 71. Similarly, an exemplary analysis 76 in FIG. 3 is extracted according to the original sentence “HANAKO HA TARO NI HON WO AGERUDARO (:Hanako will give a book to Taro.)” (Japanese written in Roman letters), and an exemplary analysis 77 in FIG. 4 is generated according to the original sentence “TARO HA TANA NI HON WO AGETA. (:Taro lifted a book onto a shelf.)” (Japanese written in Roman letters).

FIG. 5 illustrates exemplary character offsets 78 and semantic marks 79. This is an example of a sentence stored in the search-target-document DB 11 and is an example of a sentence of document ID=21 and document number=3. The offsets are character numbers that start with the head of a sentence. As indicated by the exemplary character offsets 78, an offset of “0” is assigned to the first character of the sentence, and the following offsets are associated with the following characters by incrementing the offset for each character. In, for example, a semantic analysis performed by the semantic analysis unit 33, a character string is associated with semantic marks. The semantic mark corresponding to “TARO” (Japanese written in Roman letters) is “TARO”, for example. Note that the Japanese characters illustrated in FIG. 5 mean “Taro gave a book to Hanako”.

As illustrated in FIG. 6, the index table 81 is an example of the search index 13, with minimum semantic units being stored in this search index 13. The index table 81 includes a minimum semantic unit 83, a document ID 85, a sentence ID 87, a starting-point-node position 89, a starting-point-node character string length 91, an end-point-node position 93, and an end point node 95. A document ID 85 is identification information of a document from which a minimum semantic unit 83 has been extracted. A sentence ID 87 is identification information of a sentence from which a minimum semantic unit 83 has been extracted.

A starting-point-node position 89 indicates the number of characters ranging from the head of a sentence ID 87 to the initial character of a start-point node in a minimum semantic unit 83. A starting-point-node character string length 91 indicates the number of characters of a starting point node. An end-point-node position 93 indicates the number of characters ranging from the head of a sentence ID 87 to the initial character of an end point node in a minimum semantic unit 83. An end-point-node character string length 95 indicates the number of characters of an end point node.

The initial three lines of the index table 81 correspond to three of the minimum semantic units 75 in FIG. 3. In the example of (GIVE, HANAKO, OBJECTIVE), document ID=23 and sentence ID=3. Referring to FIG. 6, the position of the starting point node (=“GIVE”) is starting-point-node position 89=8, and starting-point-node character string length 91=2. Similarly, the position of the end point node (=“HANAKO”) is end-point-node position 93=3, and the length is end-point-node character string length 95=2. In this way, elements such as all of the analyzed minimum semantic units are stored in the search index 13.

Once all of the minimum semantic units are stored, frequency information is calculated by, for example, the evaluation-value calculating unit 39. Frequency information indicates the number of times each minimum semantic unit emerges in the database. Frequency information is stored in, for example, the evaluation-value table 15. In addition, the idf value described above is calculated according to frequency information. The evaluation-value calculating unit 39 may store the calculated idf value in the evaluation-value table 15 in association with a minimum semantic unit.

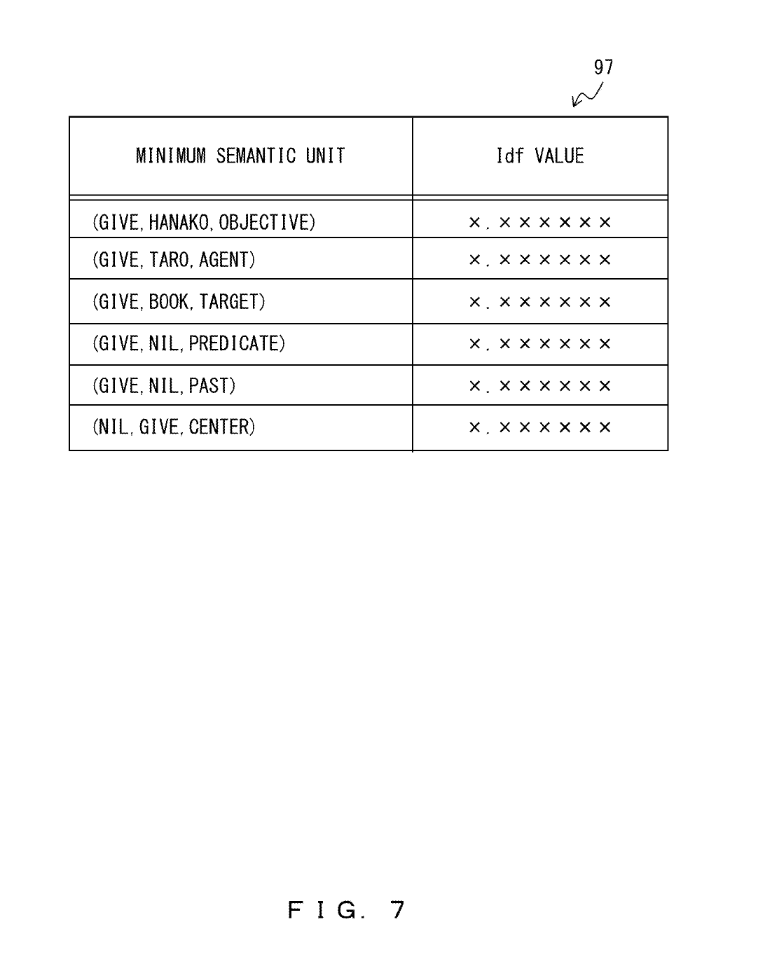

FIG. 7 illustrates an example of an evaluation-value table 99. The evaluation-value table 99 is information that associates minimum semantic units with corresponding idf values. In addition, frequency information may be stored for each minimum semantic unit.

As described above, in the preparation process, the sentence-set input unit 31 divides a document included in the search-target-document DB 11 into sentences. The semantic analysis unit 33 performs a semantic analysis to generate a directed graph and, according to the directed graph, adds information to the search index 13, as indicated by, for example, the index table 81. The semantic analysis unit 33 performs semantic analyses for all documents and all sentences and stores the results of analyzing in the search index 13. The evaluation-value calculating unit 39 calculates frequency information and an idf value. Consequently, the search-target-document DB 11 is generated, and the search index 13 and the evaluation-value table 15, both corresponding to the search-target-document DB 11, are also generated. The search index 13 allows a document ID 85, a sentence ID 87, and the position of a node within a sentence to be retrieved from a minimum semantic unit.

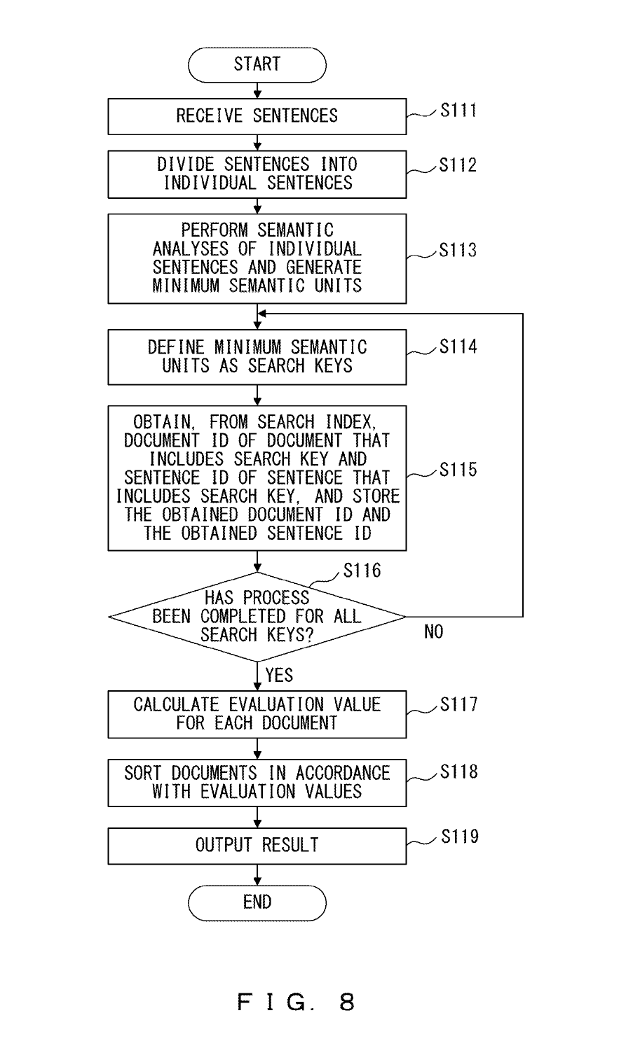

With reference to FIG. 8, the following will describe a sentence-based search process. In the search process, a semantic analysis is performed for each sentence included in a query and each search-target document, minimum semantic units are obtained, and a search is performed using the minimum semantic units as search keys. Extracted documents are ranked by calculating the evaluation values thereof using the idf values of minimum semantic units.

FIG. 8 is a flowchart illustrating a search process performed when a query is a sentence. As depicted in FIG. 8, the sentence-set input unit 31 receives sentences input as a query (S111) and divides the sentences into individual sentences (S112). The semantic analysis unit 33 performs a semantic analysis of each sentence and generates, for example, a directed graph. As in the preparation process described above, the minimum-semantic-unit generating unit 35 generates a minimum semantic unit according to the result of the semantic analysis (S113). However, a minimum semantic unit may be specified by receiving a query of the minimum semantic unit. The natural-sentence search unit 47 defines the extracted minimum semantic unit as a search key. The search key may be, for example, a minimum semantic unit included in the minimum semantic units 75 depicted in FIG. 2, e.g., (GIVE, TARO, OBJECTIVE).

The natural-sentence search unit 47 extracts, from the search index 13, elements such as a minimum semantic unit 83 that coincides with the search key and the sentence ID 87 of a sentence that includes the minimum semantic unit 83, and stores the extracted elements in, for example, the storage unit 53 (S115). That is, the natural-sentence search unit 47 extracts from the search index 13 a minimum semantic unit whose starting point node, end point node, and arc are coincident with the search key.

The natural-sentence search unit 47 repeats the process of S115 until this process is performed for all of the search keys extracted from the query 21 (S116: NO). When the process of S115 is performed for all of the search keys (S116: YES), the evaluation-value calculating unit 39 calculates the evaluation values of extracted documents with reference to the evaluation-value table 15 (S117). The ranking unit 41 sorts the extracted documents according to the calculated evaluation values (S118) and causes the output unit 43 to output the result (step 119).

Next, descriptions will be given of an example of calculation of an evaluation value under a condition in which a query is a sentence. First, the evaluation-value calculating unit 39 sets “0” as the evaluation values of all documents, and, when a search key matches a minimum semantic unit stored in the search index 13, the evaluation-value calculating unit 39 calculates an evaluation value for each sentence. The evaluation-value calculating unit 39 adds the evaluation value of the sentence to the evaluation value of a document that includes the sentence. The evaluation-value calculating unit 39 obtains the evaluation value of the document by processing all sentences that match the search key. The evaluation value of the document is the total sum of the evaluation values of the sentences included in the document.

The evaluation value of one search-target sentence n is expressed by, for example, the following formula, formula 2:

Evaluation value Sn of sentence n=(total sum of (idf value of Ki that emerges in sentence n×number of times Ki emerges in sentence n) from among (set of minimum semantic units of query (K1, K2, . . . Ki, . . . ))×M² (formula 2)

where M indicates the number of types of minimum semantic units specified as search keys in document n.

The “number of types M” is useful in evaluating a situation in which the entirety of the query is covered. Use of the square of M increases the degree of the evaluation. The “number of times Ki emerges in sentence n” is the number of minimum semantic units that are included in one search-target sentence and that are coincident with a minimum semantic unit specified as a search key.

The evaluation value of a document is expressed by, for example, the following formula, formula 3.

Evaluation value of document (D)=total of evaluation values of sentences n (Sn) (formula 3)

In this manner, the evaluation-value calculating unit 39 adds up the evaluation values of the sentences included in the document.

As an example, assume that a certain sentence m includes six minimum semantic units, each of which has idf value=2.0, and that each semantic unit emerges once. In this case, the evaluation value of the sentence m (Sm) is calculated using the following formula, formula 4.

Evaluation value (Sm)=(2×1+2×1+2×1+2×1+2×1+2×1)×6²=432.0 (formula 4)

The evaluation value becomes higher as a sentence includes more minimum semantic units that depend on the query 21.

An example of calculation of the evaluation value of a document is as follows. Assume, for example, that a document A consists of the two sentences, a sentence l and the sentence m. The sentence l has evaluation value (Sl)=18.0, and the document A has an evaluation value of 18.0+432.0=450.0.

The ranking unit 41 may rank documents in, for example, ascending or descending order of evaluation value. The output unit 43 outputs data indicating rearranged documents. In this case, using the evaluation values of extracted sentences as sort keys, the extracted sentences may be sorted and displayed in the order of the sort.

As described above, when the query input unit 23 determines that sentences have been input, the sentence-set input unit 31 divides one or more sentences included in the query 21 into individual sentences. The semantic analysis unit 33 performs a semantic analysis of each sentence and generates a directed graph. The minimum-semantic-unit generating unit 35 generates a minimum semantic unit according to the generated directed graph. Using the generated minimum semantic unit as a search key, the natural-sentence search unit 47 performs a search directed to the search index 13. The evaluation-value calculating unit 39 calculates the evaluation values of documents according to the search result, and the ranking unit 41 sorts the documents according to the evaluation values. The output unit 43 outputs the search result.

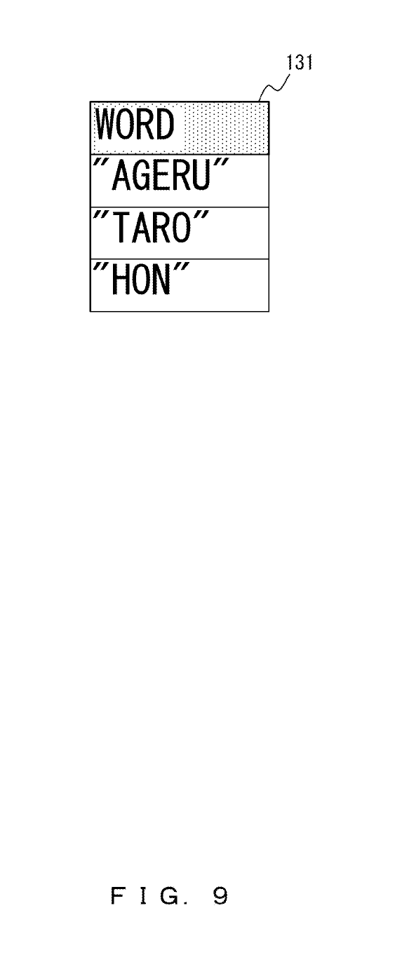

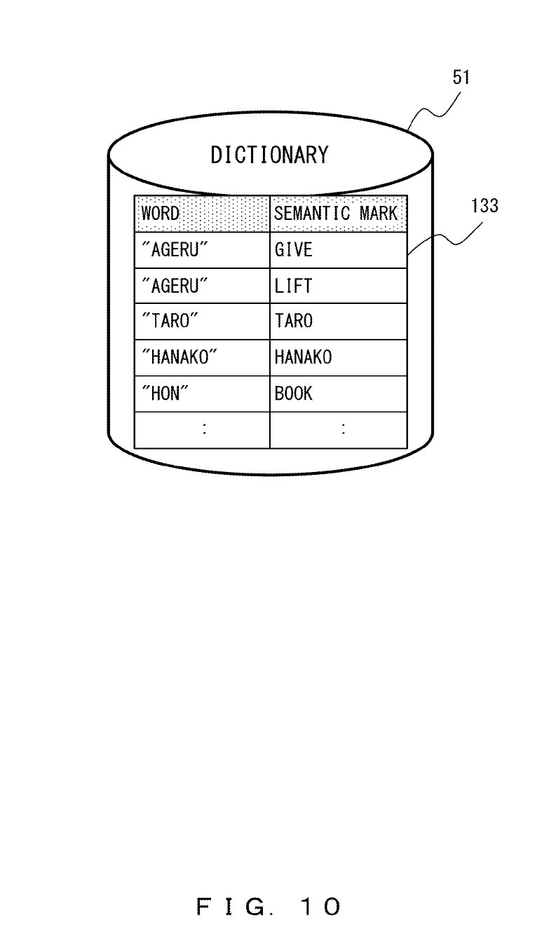

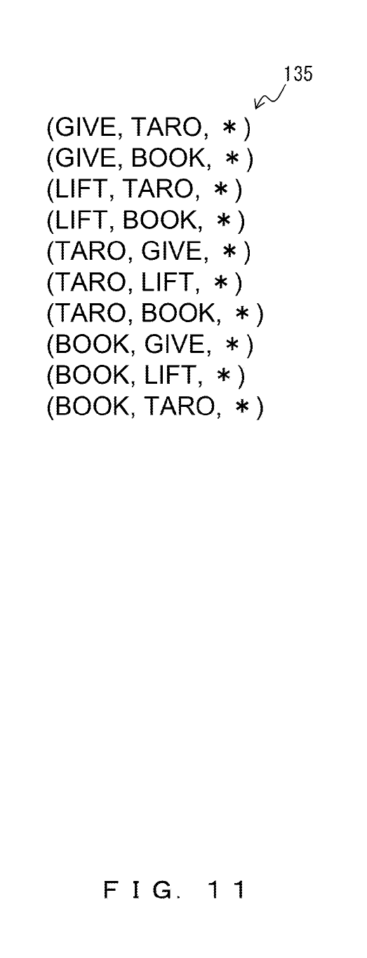

Next, with reference to FIGS. 9-18, descriptions will be given of a situation in which a keyword is input as the query 21. FIG. 9 illustrates an example of a word table 131 that includes words divided from the query 21. FIG. 10 illustrates an example of a dictionary table 133. FIG. 11 illustrates examples of search keys 135.

FIG. 9 depicts a situation in which a user performs a search by inputting “AGERU, TARO, HON” (Japanese written in Roman letters) as the query 21. The user intends to search for a sentence of “DAREKA GA DAREKA NI HON WO AGERU. (: Someone gives a book to another person.)”. “DAREKA (:someone)” includes “TARO” (Japanese written in Roman letters).

As depicted in FIG. 9, the word table 131, which indicates words divided from the query 21, includes “AGERU”, “TARO”, and “HON” (Japanese written in Roman letters). The word table 131 is generated at, for example, the keyword input unit 25.

As depicted in FIG. 10, the dictionary table 133 is an example of information included in the dictionary 51. The dictionary table 133 includes, for example, semantic marks “GIVE” and “LIFT”, which correspond to “AGERU” (Japanese written in Roman letters), and a semantic mark “TARO”, which corresponds to “TARO” (Japanese written in Roman letters). The dictionary table 133 is referred to when the keyword converting unit 27 converts a word included in the word table 131 into a semantic mark included in the dictionary table 133.

As depicted in FIG. 11, the search keys 135 are generated from the combinations of semantic marks that correspond to extracted words. That is, when four semantic marks “GIVE”, “LIFT”, “TARO”, and “BOOK”, each of which corresponds to any of the three words “AGERU”, “TARO”, and “HON” (Japanese written in Roman letters), are retrieved, twelve search keys, each of which includes two semantic marks selected from the four semantic marks, are extracted. Each search key is expressed by two semantic marks and one arc and is expressed as, for example, (GIVE, TARO, *), (GIVE, BOOK, *), . . . . Note that “*” indicates an arbitrary arc.

A search key is typically expressed as (semantic mark A, semantic mark B, *), where semantic mark A≠semantic mark B. Assume that a search is performed for (semantic mark A, semantic mark B, *) and (semantic mark B, semantic mark A, *). In this case, an arrangement may be made to extract only combinations of a noun and a verb. The search-key generating unit 29 generates search keys 135.

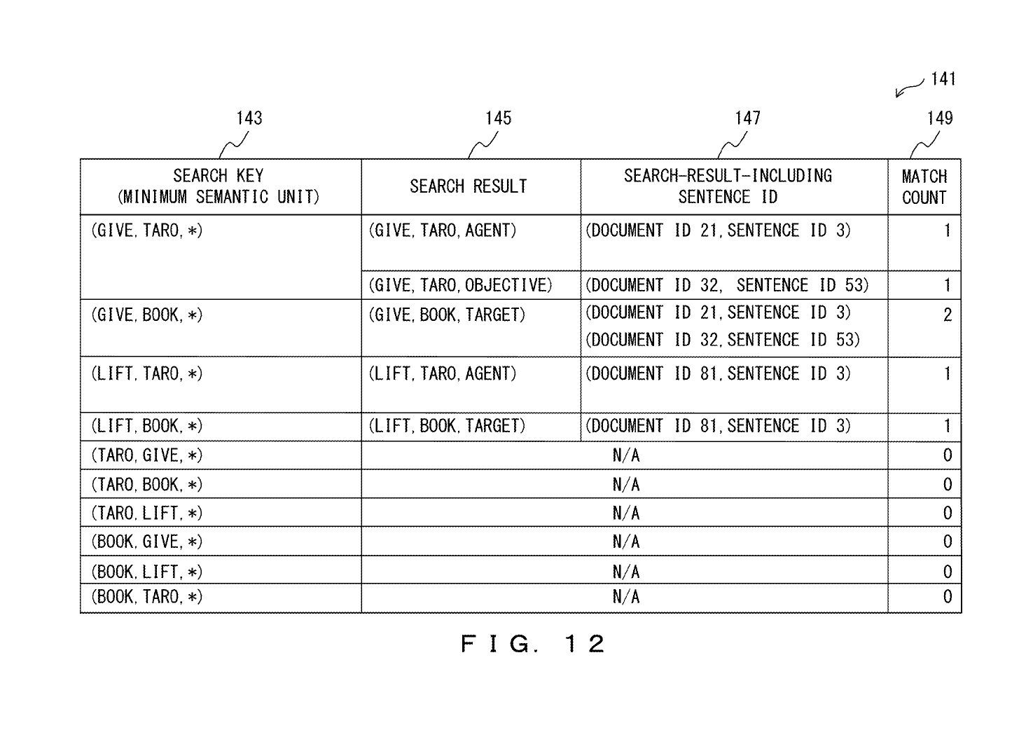

FIG. 12 illustrates an exemplary search result 141. The search result 141 is information indicating an exemplary search result. The search result 141 includes search keys 143, search results 145, search-result-including-sentence IDs 147, and match counts (numbers of matches) 149. The search key 143 is, for example, a search key 135 generated by the search-key generating unit 29. The search result 145 is a minimum semantic unit that is coincident with a search key 135 extracted from the search index 13. The search-result-including-sentence ID 147 is identification information of a document and a sentence that include a minimum semantic unit of a search result 145. The match count 149 is the number of sentences extracted as a result of a search.

As an example, in a search performed using (GIVE, TARO, *) as a search key, search results 97 and 98 in the index table 81 in FIG. 6 match the search key. With reference to the search results 97 and 98, the following information is extracted according to the document ID 85 and the sentence ID 87.

That is, a sentence that includes the search key (GIVE, TARO, AGENT) is (document ID 21, sentence ID 3), and a sentence that includes the search key (GIVE, TARO, OBJECTIVE) is (document ID 32, sentence ID 53). Similarly, searches are performed for the other combinations.

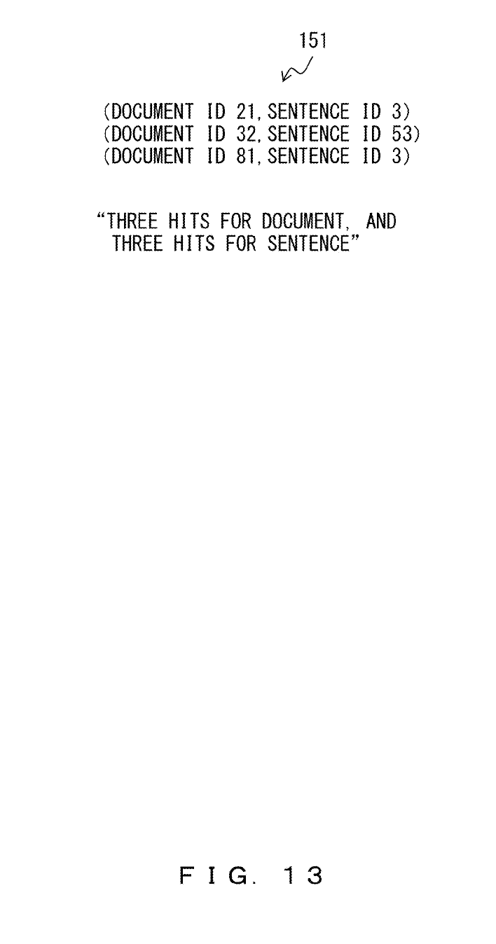

FIG. 13 illustrates an exemplary screen display 151 indicating a search result. As depicted in FIG. 13, the exemplary screen display 151 indicates that three sentences have been extracted as search results by deleting overlap in the search-result-including-sentence IDs 147 in the search result 141. In particular, (document ID 21, sentence ID 3), (document ID 32, sentence ID 53), and (document ID 81, sentence ID 3) have been extracted.

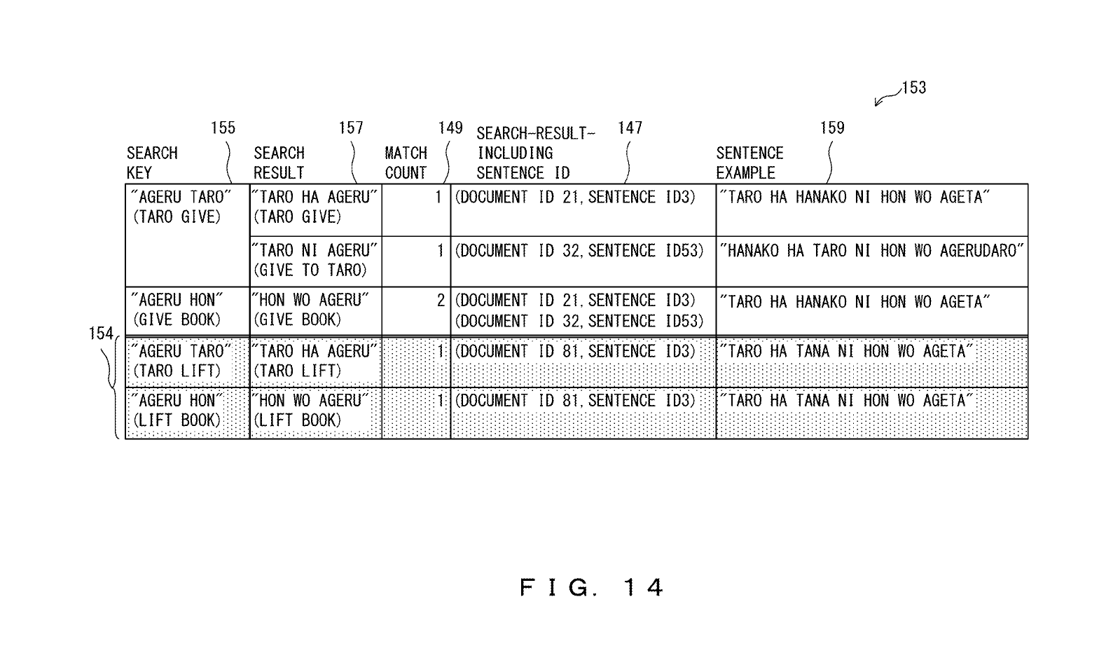

The search result 141 in FIG. 12 and the exemplary screen display 151 in FIG. 13 include, for example, a search result that corresponds to “LIFT”, which the user does not intend to have extracted. Accordingly, with reference to FIGS. 14-17, the following will describe table conversion for displaying a detection result that meets a user's intentions more precisely or for a display that facilitates a narrowing down of intended results. FIGS. 14-17 illustrate examples of converted versions of a table indicating search results.

As illustrated in FIG. 14, a table conversion example 153 indicates search keys 155, search results 157, match counts 149, search-result-including-sentence IDs 147, and sentence examples 159. The search key 155 is a word expression of the portion of a search key 135 that corresponds to semantic marks. When the keyword converting unit 27 stores in, for example, the storage unit 53 correspondences between semantic marks and words included in a query 21 input by a user for a search, the word expressions are achievable by replacing the semantic marks with corresponding words. Each minimum semantic unit is replaced with two words.

The search result 157 is a sentence that is a search result 145 converted into a superficial character string. Conversion may be based on, for example, a starting-point-node position 89 and an end-point-node position 93 of the search index 13. The sentence example 159 is a sentence that corresponds to a sentence ID in a search-result-including-sentence ID 147. When a plurality of sentence IDs are present, one of these sentence IDs may be selected under a certain standard or may be selected at random. A search result 154 is a search result that corresponds to “LIFT”, which does not meet the user's intentions.

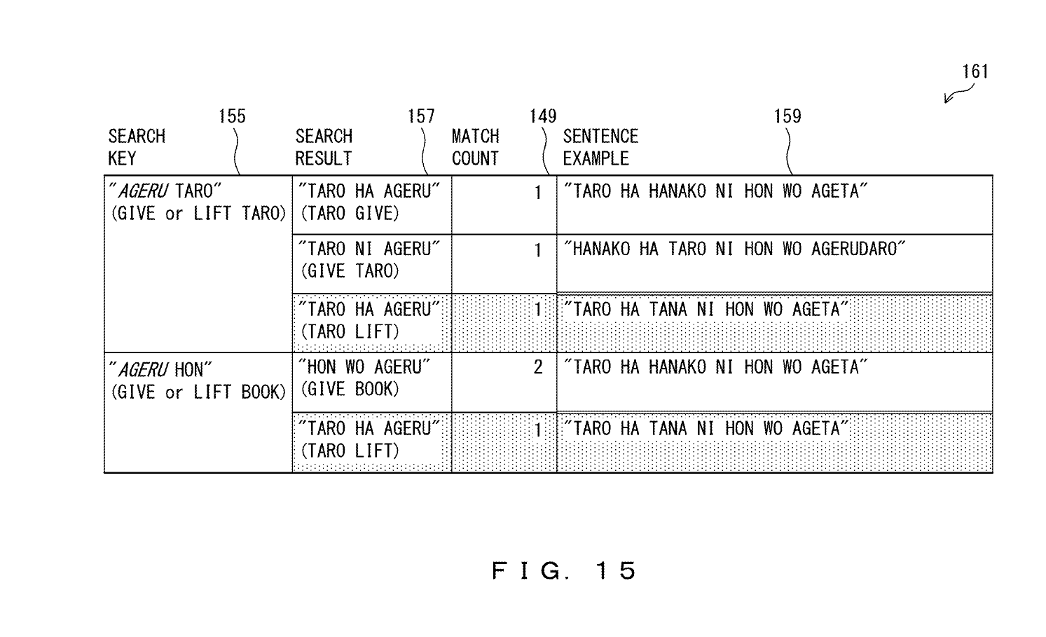

A table conversion example 161 in FIG. 15 is obtained by sorting the table conversion example 153 using search keys 155. The table conversion example 161 includes search keys 155, search results 157, match counts 149, and sentence examples 159. Although the search-result-including-sentence IDs 147 have been deleted from the table conversion example 161, correspondences therewith are preferably stored in, for example, the storage unit 53. In the table conversion example 161, a plurality of cells that include the same search key 155 are collected into one set.

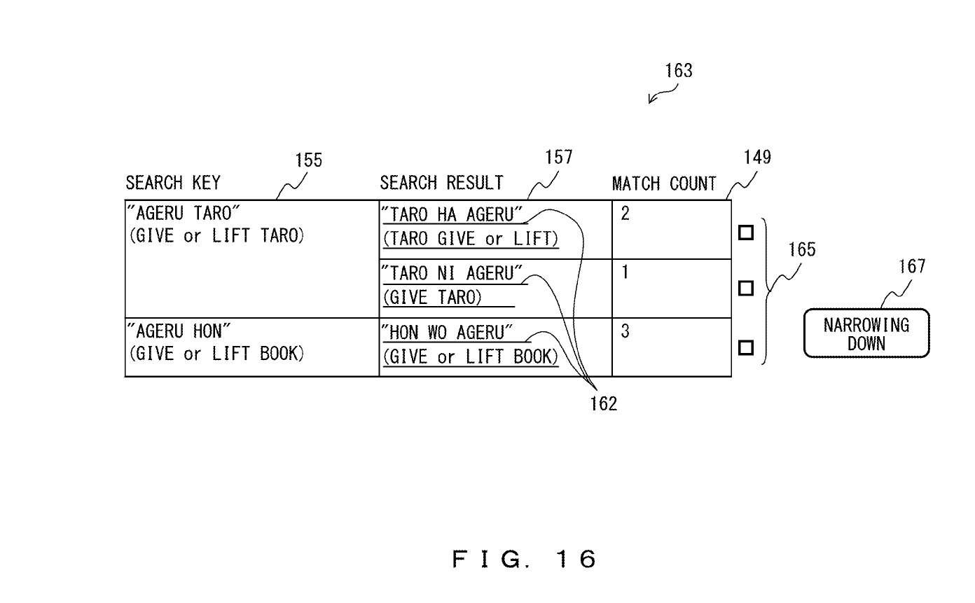

FIG. 16 depicts an exemplary screen display 163. The exemplary screen display 163 is an example in which the sentence examples 159 have been deleted from the table conversion example 161 with items being displayed for each search result 157. As an example, when a plurality of lines include an identical search result 157, the top line is maintained but the other lines are deleted. The match count 149 indicates the total number of retrieved items that correspond to those lines. The exemplary screen display 163 includes check boxes 165 and a narrowing-down button 167. The check boxes 165 are check boxes for the selection of lines, and the narrowing-down button 167 is selected via clicking or touching to narrow down the focus to a line that corresponds to a checked check box 165.

In the search results 157 in FIG. 15, two lines correspond to “TARO HA AGERU” (Japanese written in Roman letters) and each includes “1” as a match count. In the search results 157 of the exemplary screen display 163 in FIG. 16, “2” is indicated as the sum of the match counts 149, and the lines have been collected into one. In the exemplary screen display 163, links may be added to the search results 157, as indicated by underlines 162, and words within the retrieved sentences can be displayed by selecting the links.

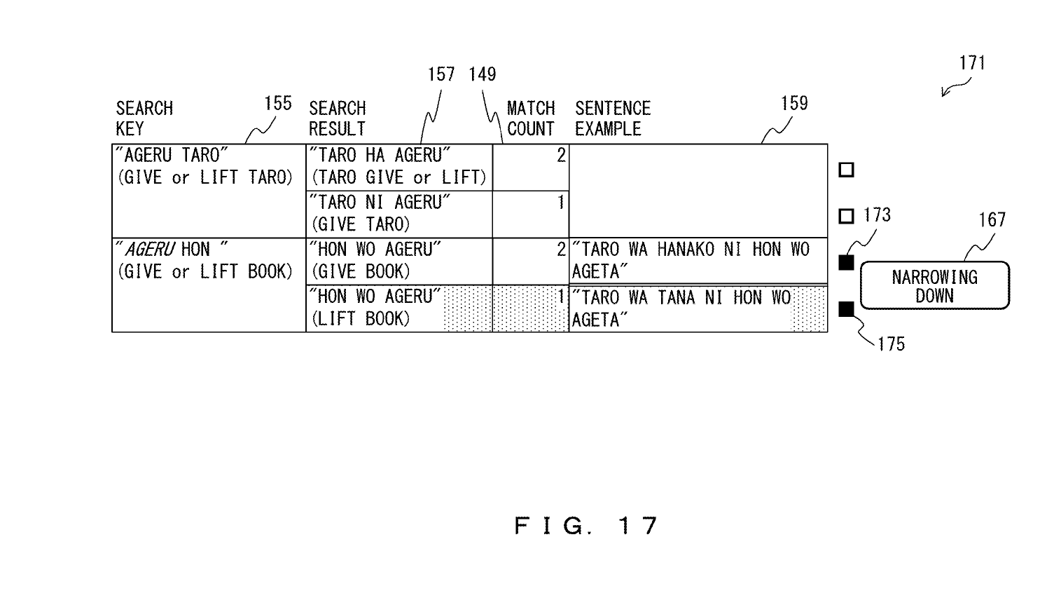

FIG. 17 depicts a table expansion example 171. As illustrated in FIG. 17, the table expansion example 171 indicates the exemplary screen display 163 with the check box 165 for the field “HON WO AGERU” (Japanese written in Roman letters) being selected and with the narrowing-down button 167 being pressed. The selected line is expanded into two, and check boxes 173 and 175, each displayed for one of the lines obtained via the expansion, are both in a selected state. As many check boxes as the number of lines obtained via expanding are displayed, and all of the check boxes are put in the selected state. Selecting check boxes in this way causes more-detailed extracted results to be displayed. The search key 155 that corresponds to “HON WO AGERU” (Japanese written in Roman letters) is “AGERU HON” (Japanese written in Roman letters), which is displayed using italics in the table expansion example 171.

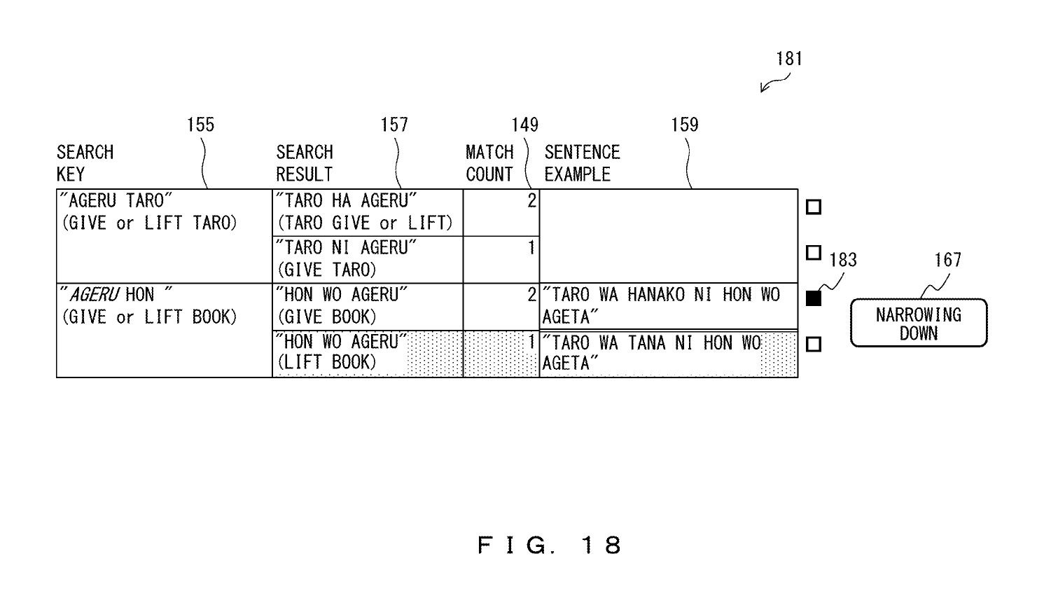

FIG. 18 illustrates a selection example 181. In the embodiment, “HON WO AGERU (:give book)” (Japanese written in Roman letters) is selected using a check box 183 because the user intends to search for the sentence “DAREKA GA DAREKA NI HON WO AGERU. (: Someone gives a book to another person.)”. That is, the user sees the two sentence examples “TARO HA HANAKO NI HON WO AGETA. (:Taro gave a book to Hanako.)” and “TARO HA TANA NI HON WO AGETA. (:Taro lifted a book onto a shelf.)” (Japanese written in Roman letters) and determines that “TARO HA TANA NI HON WO AGETA. (:Taro lifted a book onto a shelf.)” (Japanese written in Roman letters) is an intended sentence example. Then, the check box 183 for the line “TARO HA HANAKO NI HON WO AGETA. (Taro gave a book to Hanako.)” (Japanese written in Roman letters) is selected, and the narrowing-down button is pressed.

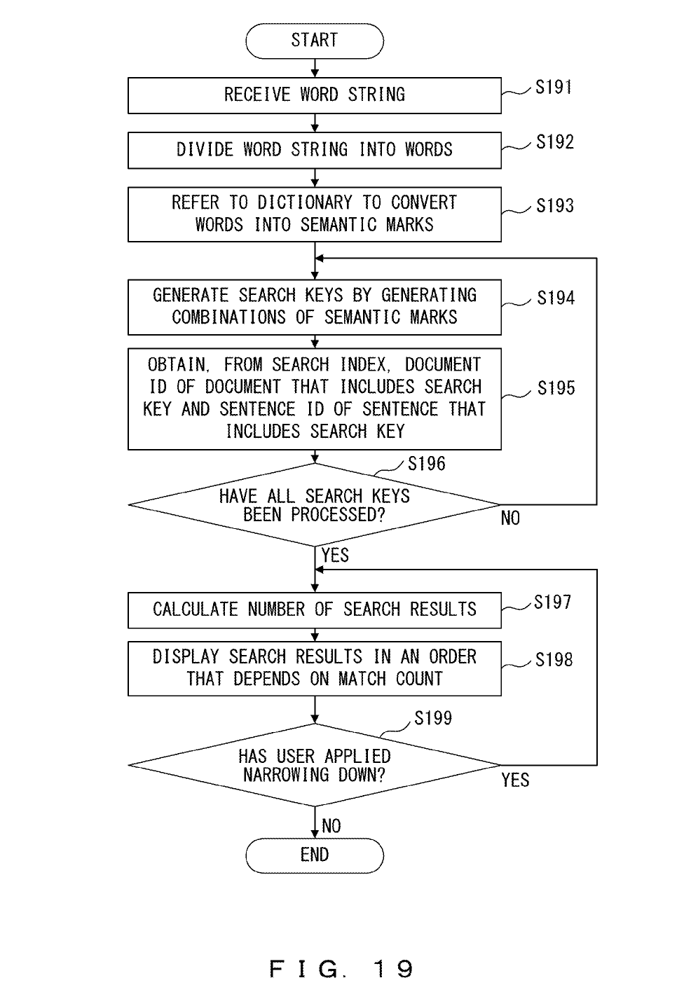

With reference to FIG. 19, the following will describe a search process performed when the query 21 is a keyword. FIG. 19 is a flowchart illustrating a search process based on a keyword. The query input unit 23 first receives the query 21. The query input unit 23 determines that the query 21 is a word string that includes at least one word (S191).

The keyword input unit 25 divides the word string of the query 21 into words (S192). The keyword input unit 25 also refers to the dictionary 51 to convert the words into semantic marks (S193). The search-key generating unit 29 generates search keys by generating the combinations of the semantic marks obtained from the conversion (S194).

The keyword search unit 45 obtains from the search index 13 the document ID of a document that includes a search key and the sentence ID of a sentence that includes the search key (S195). The keyword search unit 45 repeats S195 until the process of S195 is completed for all of the search keys (S196: NO), and, when the processes are completed (S196: YES), the keyword search unit 45 calculates the number of search results (S197).

The output unit 43 displays the search results in an order that depends on match count (S198). When the keyword search unit 45 detects from an output result that the user has applied narrowing-down (S199: YES), the keyword search unit 45 returns to S197 to repeat the processes. When, for example, narrowing-down is not applied within a certain time period (S199: NO), the keyword search unit 45 ends the processes.

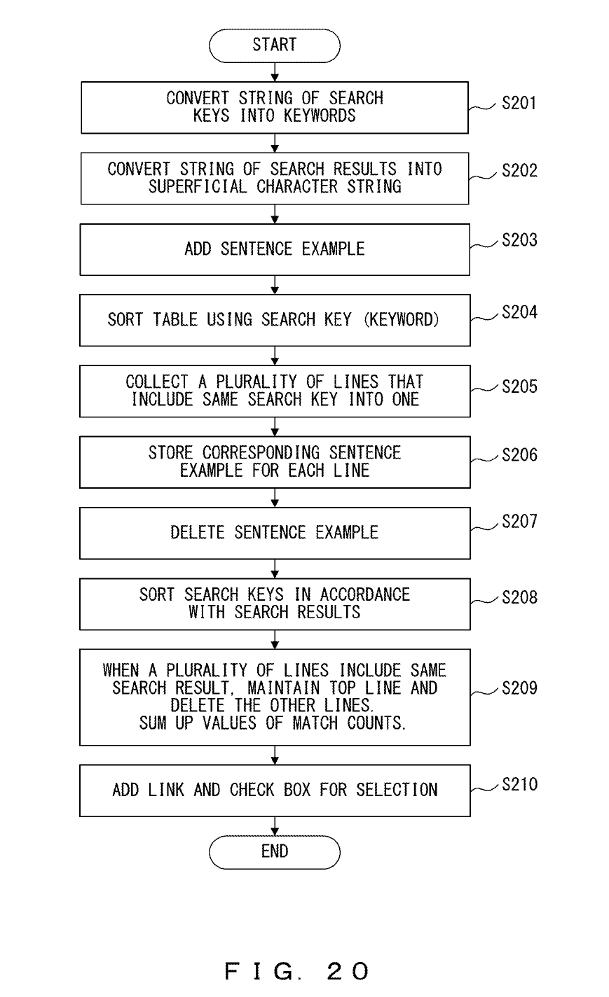

The following will describe a table-converting process with reference to FIG. 20. FIG. 20 is a flowchart illustrating an exemplary table-converting process. As illustrated in FIG. 20, the output unit 43 converts a string of search keys in a table indicating displayed results into keywords (S201). As an example, the output unit 43 converts the search keys 143 in FIG. 12 into the search keys 155 in

FIG. 14. The output unit 43 converts a string of search results into a superficial character string (S202). As an example, the output unit 43 converts the search results 145 in FIG. 12 into the search results 157 in FIG. 14.

The output unit 43 adds a sentence example to a table (S203). As an example, the output unit 43 adds a sentence example 159 to the table conversion example 153 in FIG. 14. The output unit 43 sorts the table using a search key (S204). As an example, the output unit 43 sorts the search keys 155 in FIG. 14 as indicated by the search keys 155 depicted in FIG. 15. As an example, the output unit 43 collects a plurality of lines that include the same search key into one in the table conversion example 161 (S205). For each line within the table conversion example 161, the output unit 43 stores a corresponding sentence example in, for example, the storage unit 53 (S206). The output unit 43 deletes the sentence examples from the table conversion example 161 (S207) and sorts the search keys 155 in accordance with the search results 157 (S208). When a plurality of lines are present for the same search result 157, the output unit 43 maintains the top line, deletes the other lines, and sums up the values of the match counts 149 (S209). In addition, the output unit 43 adds desired links and check boxes on an as-needed basis, thereby generating, for example, the exemplary screen display 163 in FIG. 16 (S210).

As described above, the information search apparatus 1 in accordance with the embodiment includes the query input unit 23 that determines which of a word string or a sentence an input query 21 is and that selects a process in accordance with which of a word string or a sentence the input query 21 is. In the case of the input query 21 that is a word string, the keyword input unit 25 divides the word string of the query 21 into words. The keyword converting unit 27 refers to the dictionary 51 to convert the words obtained via the dividing into semantic words. The search-key generating unit 29 generates search keys by generating the combinations of semantic words obtained via the conversion. The keyword search unit 45 extracts from the search index 13 minimum semantic units that match a search key, and defines these minimum semantic units as search results. The output unit 43 outputs the search results in, for example, a tabular format. The output unit 43 outputs the results in a form such that a user can apply a narrowing-down in accordance with the results, and the output unit 43 changes the displayed results according to the user's selection.

In the case of the query 21 that is a sentence set, the sentence-set input unit 31 divides the query 21 into sentences. The semantic analysis unit 33 performs a semantic analysis of each sentence obtained via the dividing. According to the results of the semantic analyses, the minimum-semantic-unit generating unit 35 generates a minimum semantic unit for each sentence. The natural-sentence search unit 47 searches the search index 13 for the minimum semantic units generated by the minimum-semantic-unit generating unit 35 and extracts search results such as document IDs and sentence IDs. According to the extracted results and the evaluation-value table 15, the evaluation-value calculating unit 39 calculates the evaluation values of the sentences or the documents of the extracted results. The ranking unit 41 sorts the sentences or the documents of the extracted results according to the calculated evaluation values. The output unit 43 outputs a result.

The information search apparatus 1 includes functions to register a new document in the search-target-document DB 11, to generate minimum semantic units by performing a semantic analysis for the registered document, to register the minimum semantic units in the search index 13, and to store evaluation values in the evaluation-value table 15.

As described above, whether the query 21 is a sentence or a word, the information search apparatus 1 may automatically make a determination to perform a search. The information search apparatus 1 is capable of searching for an intended document in accordance with the result of a semantic analysis of the query 21. This improves the accuracy of the search. An increase in the number of keywords included in the query 21 or the inputting of a sentence does not make a user's intentions vague, so that a search result contrary to the user's intentions can be prevented from being incorporated. Simple examples have been cited in the embodiment, and an increased number of keywords can be addressed using the configuration and the algorithm.

The table presented to the user as a search result displays search results and corresponding match counts. The presented table may display search results sorted using evaluation values and match counts. This enables the time that would be spent on extracting intended information from search results to be shortened, and enables intended information to be retrieved more readily.

Introducing evaluation values related to a sentence allows, for example, an order of priority to be set with reference to minimum semantic units repeated in the same sentence. As an example, sentences exclusively directed to a particular theme can be effectively extracted. Introducing an evaluation value for each document allows weights to be assigned in consideration of both the evaluations of minimum semantic units for all search-target documents and the manner of emergence of the minimum semantic units in sentences.

Minimum semantic units are based on a partial structure of a directed graph, and hence a search based on matching under the minimum semantic units may be performed more flexibly than a search based on matching under the directed graph. Hence, documents may be efficiently narrowed down so that documents that include intended semantic expressions can be easily selected. The information search apparatus 1 in accordance with the aforementioned embodiment is particularly useful in searching for, for example, papers, patents, or general web pages.

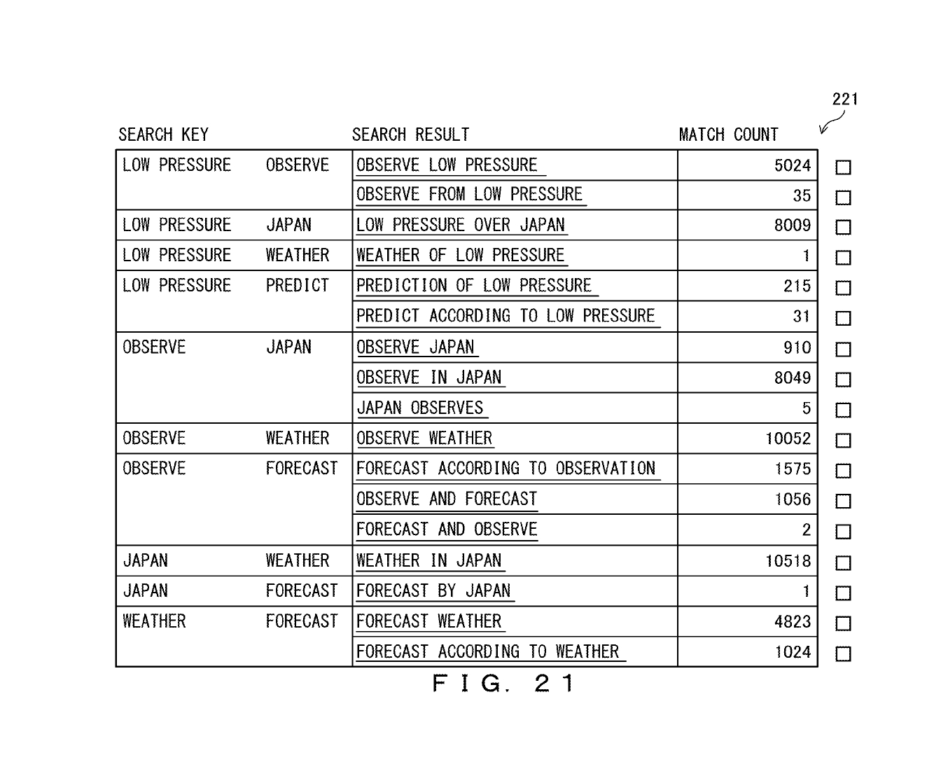

(Variation 1) The following will describe variation 1 with reference to FIGS. 21-26. Variation 1 is a variation of a displayed search result. FIGS. 21-26 illustrate exemplary screen displays indicating search results. In variation 1, the document “forecast weather in Japan by observing a low pressure” is searched for. A user enters, for example, the keywords “low pressure, observe, Japan, weather, forecast”.

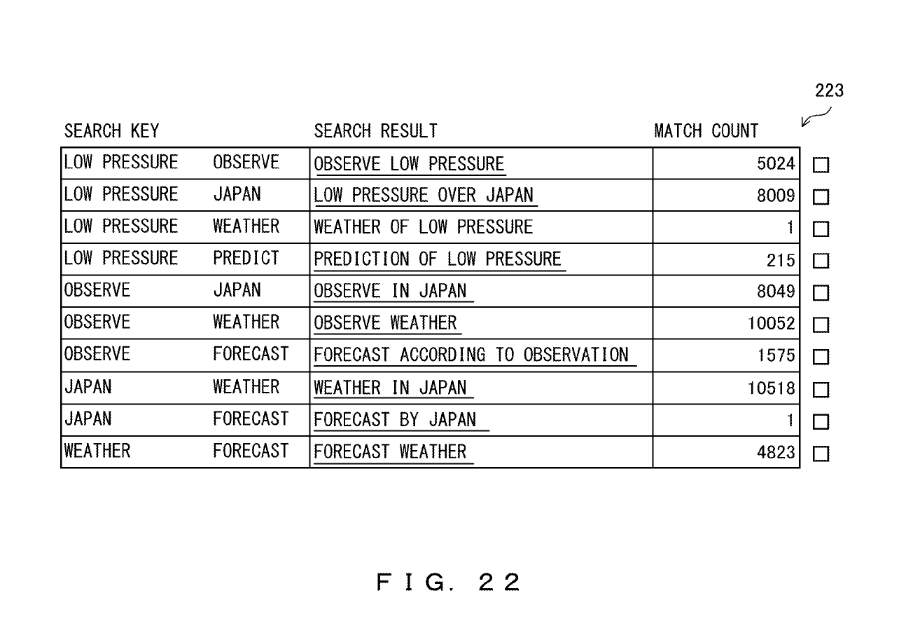

FIG. 21 illustrates a search result 221. The search result 221 is an exemplary search result based on the keywords above. FIG. 22 illustrates another search result 223. The search result 223 is the search result 221 with only an extracted result having the highest match count being displayed for each search key. This decreases the number of search results seen by the user. The search result 223 displays items that frequently emerge in the database and thus can present all information estimated to be needed by the user.

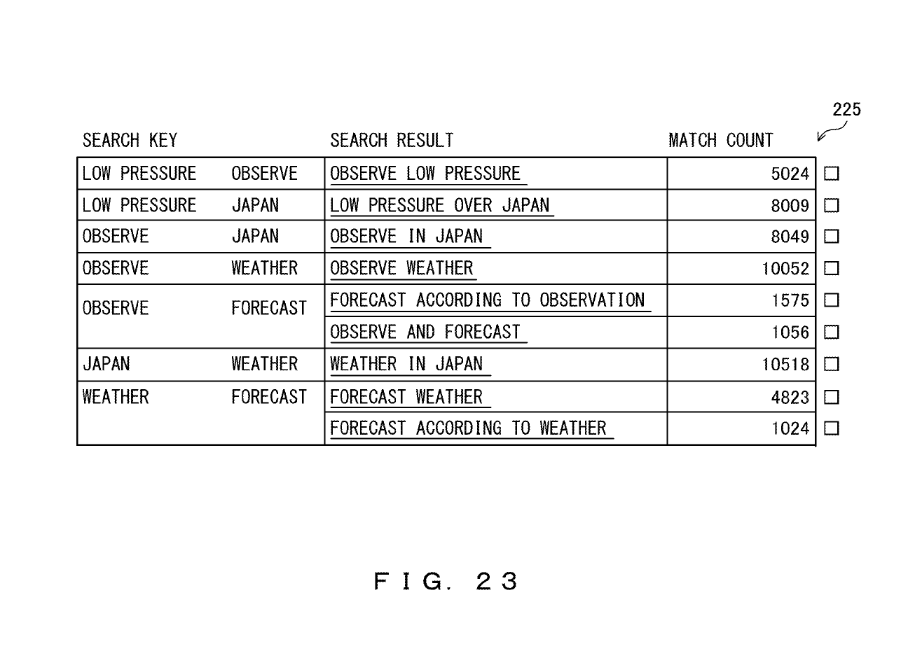

FIG. 23 illustrates a search result 225. The search result 225 is the search result 221 with only results whose match counts is 1000 or larger being displayed for each search key. This also decreases the number of search results seen by the user.

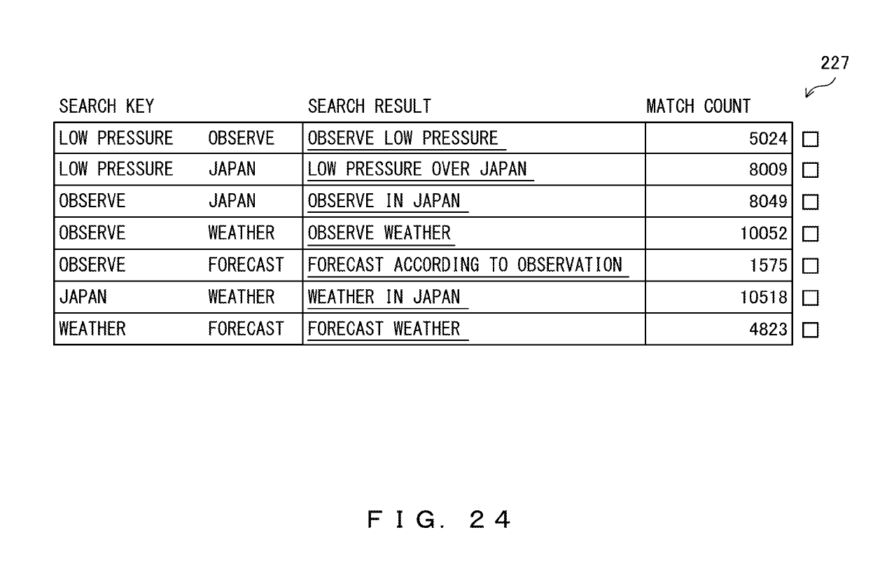

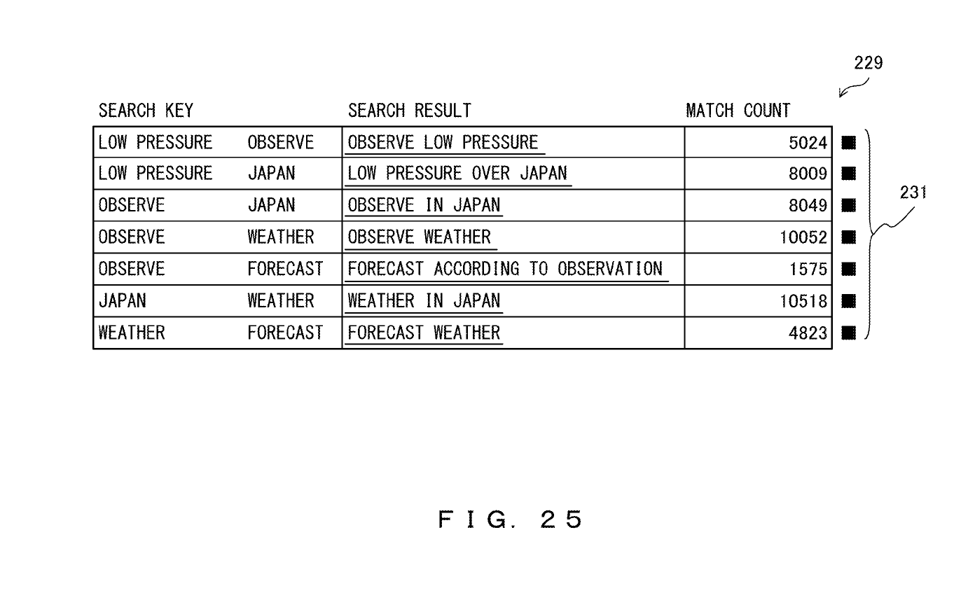

FIG. 24 illustrates a search result 227. The search result 227 displays, for each search key, only a result having a highest match count that is 1000 or larger. FIG. 25 illustrates a search result 229. The search result 229 indicates the search result 227 with all of the items being checked, i.e., with all check boxes 231 being checked. In the search result 229, the user only needs to uncheck check boxes, and hence such a display scheme is efficient when the user checks many boxes.

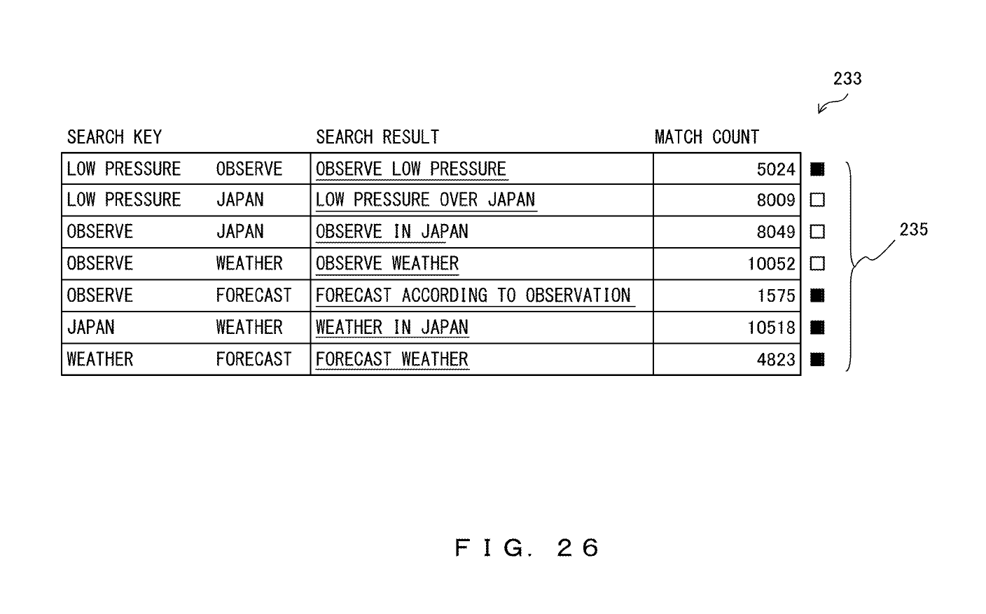

FIG. 26 illustrates an exemplary screen display 233. The exemplary screen display 233 indicates an example in which, in accordance with the user's intentions “forecast weather in Japan by observing a low pressure”, selection is made as indicated by check boxes 235. This allows search results in which the user's intentions are correctly reflected to be obtained.

As described above, variation 1 provides a screen interface that displays a search result in a manner such that the user can easily understand the search result and thus can readily apply narrowing-down. Narrowing-down can be applied according to the relationship between keywords so that an intended search result can be found more efficiently. That is, a semantic relationship between words is focused on, and, according to the relationship, the user may apply narrowing-down using the screen interface.

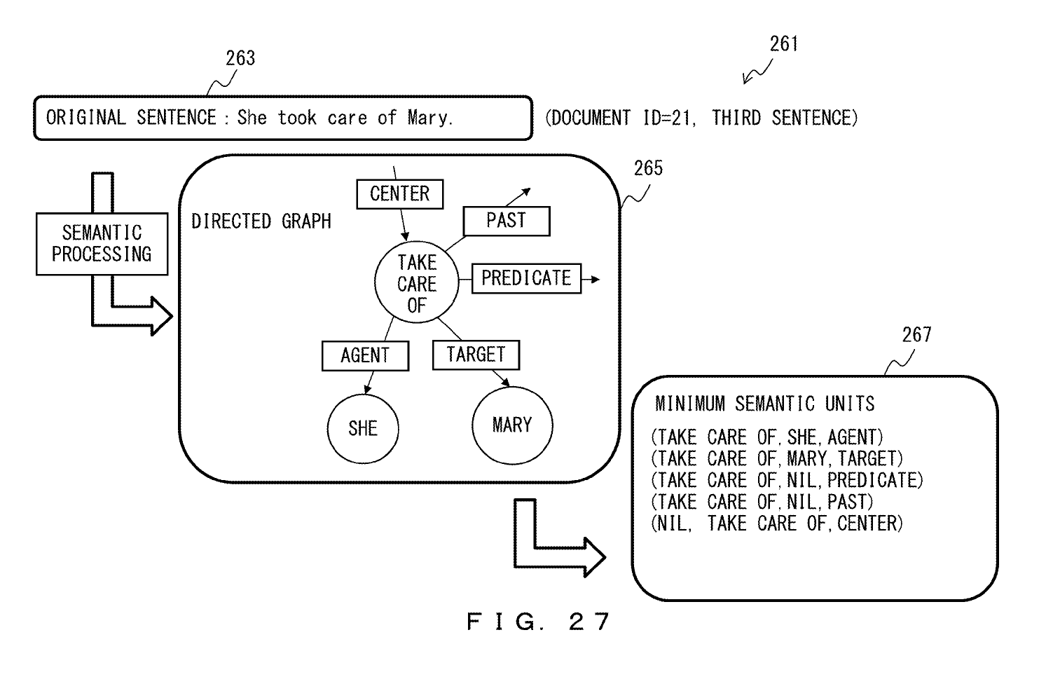

(Variation 2) With reference to FIGS. 27-35, the following will describe an example in which the present invention is applied to a non-Japanese language. Variation 2 will be described with reference to English. The configuration and the operation of an information search apparatus in accordance with variation 2 are similar to those in the aforementioned embodiment and variation 1, and hence overlapping features will not be described herein.

FIGS. 27-29 illustrate exemplary analyses of sentences in a preparation process for generating, for example, a search index 13. When a document that needs to be stored in the search-target-document DB 11 is input, the sentence-set input unit 31 divides the input document into sentences. The semantic analysis unit 33 performs a semantic analysis for each sentence obtained via the dividing. The semantic analysis unit 33 divides the sentences into words, which are defined as nodes, and analyzes relationships between the words so as to extract relationships between nodes, and to extract a starting point node, an end point node, and node positions and character string lengths within the sentences. The minimum-semantic-unit generating unit 35 generates a minimum semantic unit according to the result of the semantic analysis.

In FIG. 27, an original sentence 263 is the sentence “She took care of Mary.” The semantic analysis unit 33 performs a semantic analysis to generate a directed graph 265 and a minimum semantic unit 267. In FIG. 27, “SHE”, “TAKE CARE OF”, and “MARY” are nodes. For English, semantic marks may be identical with words in a sentence. In the case of English, since two or more words may form one meaning, the sentence is converted into one or more sets each consisting of one word, or one or more sets each consisting of two or more words.

In FIG. 27, the arc from the node “TAKE CARE OF” to the node “SHE” is an “AGENT”, and the arc from the node “TAKE CARE OF” to the node “MARY” is a “TARGET”. “PAST” and “PREDICATE” are arcs that have “TAKE CARE OF” as a starting-point node and that do no not have an end-point node. “CENTER” is an arc that does not have a starting-point node and has “TAKE CARE OF” as an end-point node.

In the generating of minimum semantic units, the semantic analysis unit 33 extracts arcs from a directed graph and generates, for example, minimum semantic units 267. The generating method is similar to the generation method used in the aforementioned embodiment.

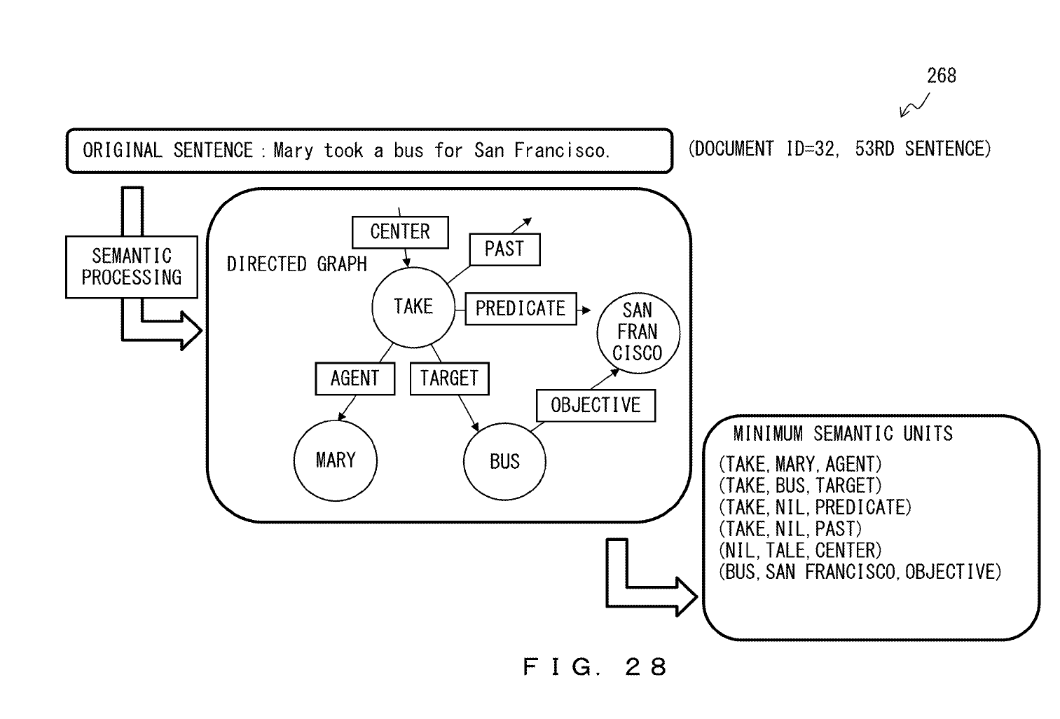

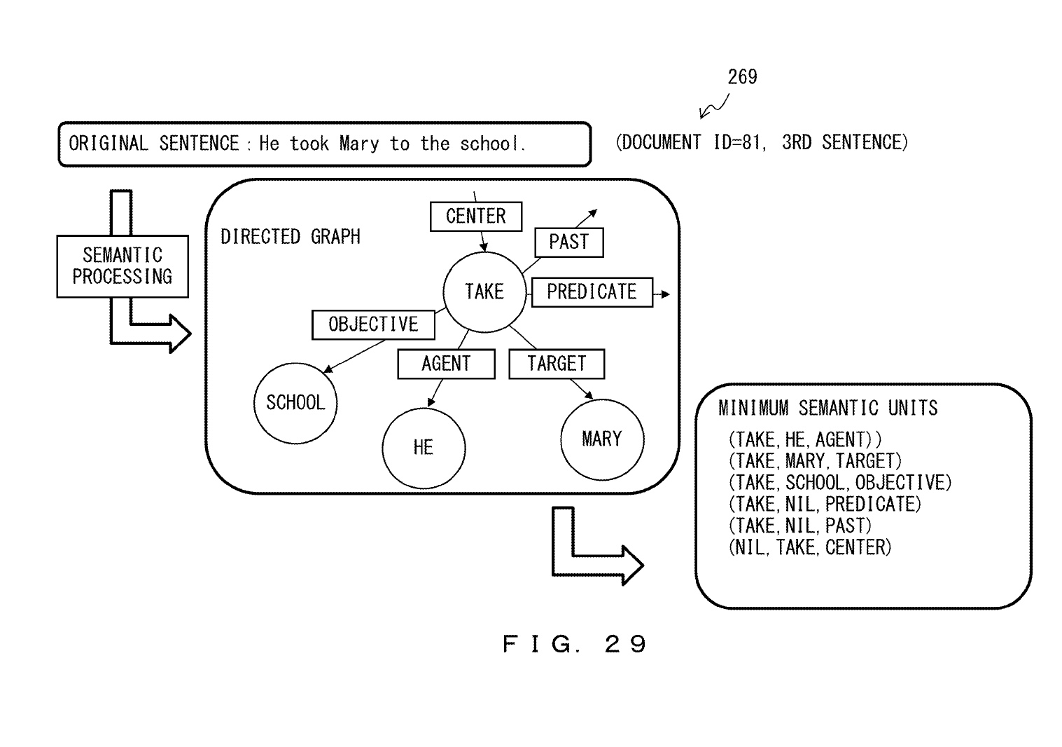

As described above, the minimum semantic units 267 are extracted from the original sentence 263. Similarly, an exemplary analysis 268 in FIG. 28 is extracted according to the original sentence “Mary took a bus for San Francisco.”; an exemplary analysis 269 in FIG. 29 is generated according to the original sentence “He took Mary to the school.”

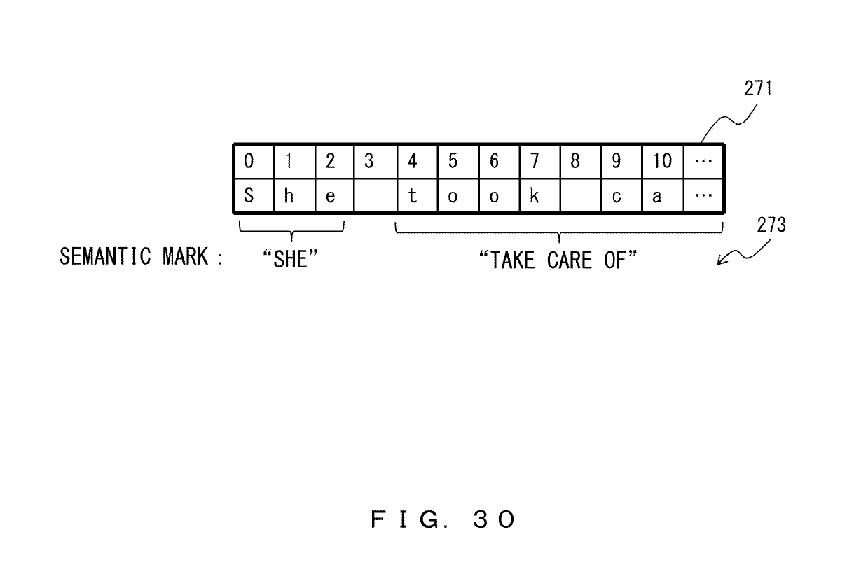

FIG. 30 illustrates character offset examples 271 and semantic marks 273. This example indicates an exemplary analysis of the original sentence 263 in FIG. 27, e.g., an example of the sentence with document ID=21 and sentence number=3. In the character offset examples 271, the offset of “SHE” is “0”, and the character string length thereof is “3”. The offset of “TAKE CARE OF” is “4”, and the character string length thereof is “12”. As described above, as in the case of Japanese sentences, English sentences, e.g., the original sentence 263, are stored in the search-target-document DB 11, and semantic analyses of the documents stored in the search-target-document DB 11 are performed for each sentence, with the result that a search index 13 is generated.

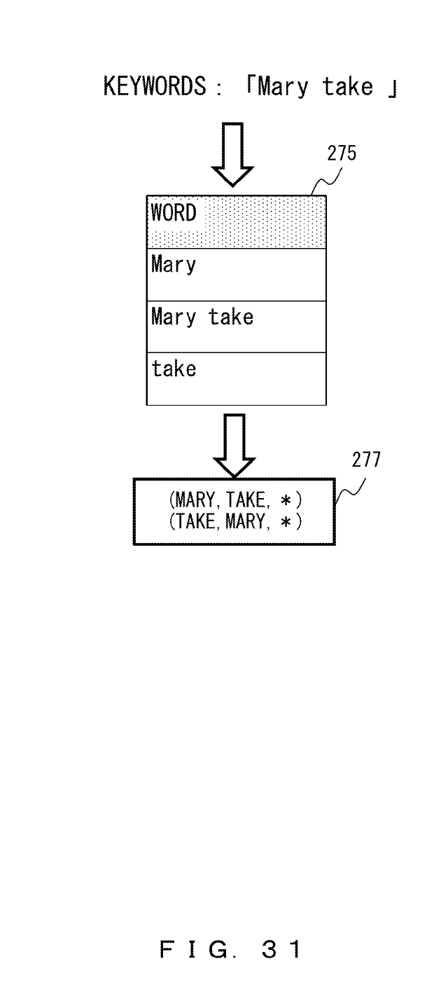

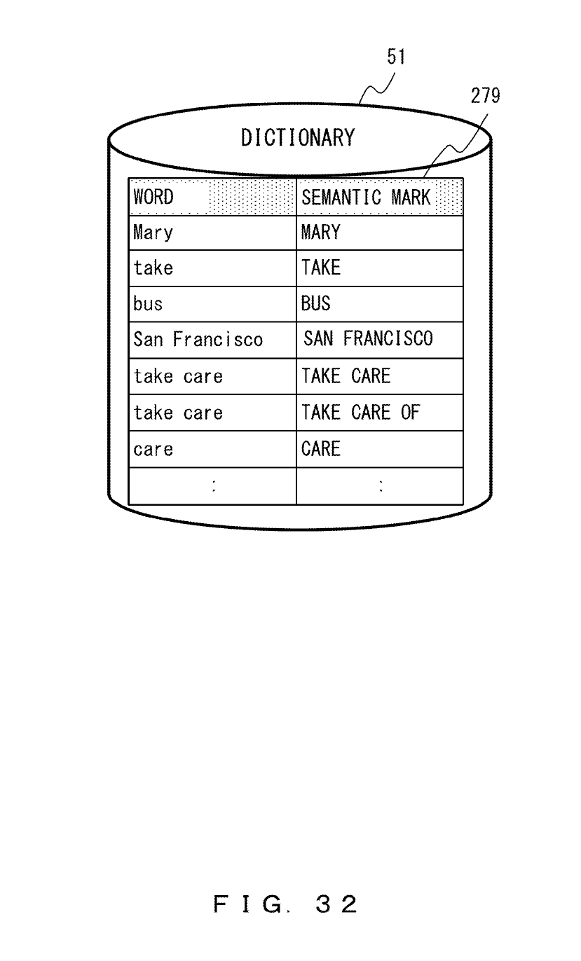

Next, with reference to FIGS. 31-35, descriptions will be given of a search process performed when an English phrase is entered as the query 21. FIG. 31 depicts a semantic analysis performed when “Mary take” is entered as the query 21. FIG. 32 depicts an example of a dictionary table 279.

As indicated in FIG. 31, when the query input unit 23 determines that the query 21 is a keyword, the keyword input unit 25 divides the query 21 into words. In the case of English, since two or more words may form one meaning, the keyword input unit 25 converts the query 21 into one or more sets each consisting of one word, or one or more sets each consisting of two or more words. In FIG. 31, the keyword input unit 25 expands “Mary take” into the three elements, “Mary”, “Mary take”, and “take”. The keyword converting unit 27 refers to the dictionary table 279 stored in the dictionary 51 for the words obtained via the expanding. As the dictionary table 279 does not include “Mary take”, the search-key generating unit 29 generates minimum semantic units based on “Mary” and “take”, as indicated by search keys 277.

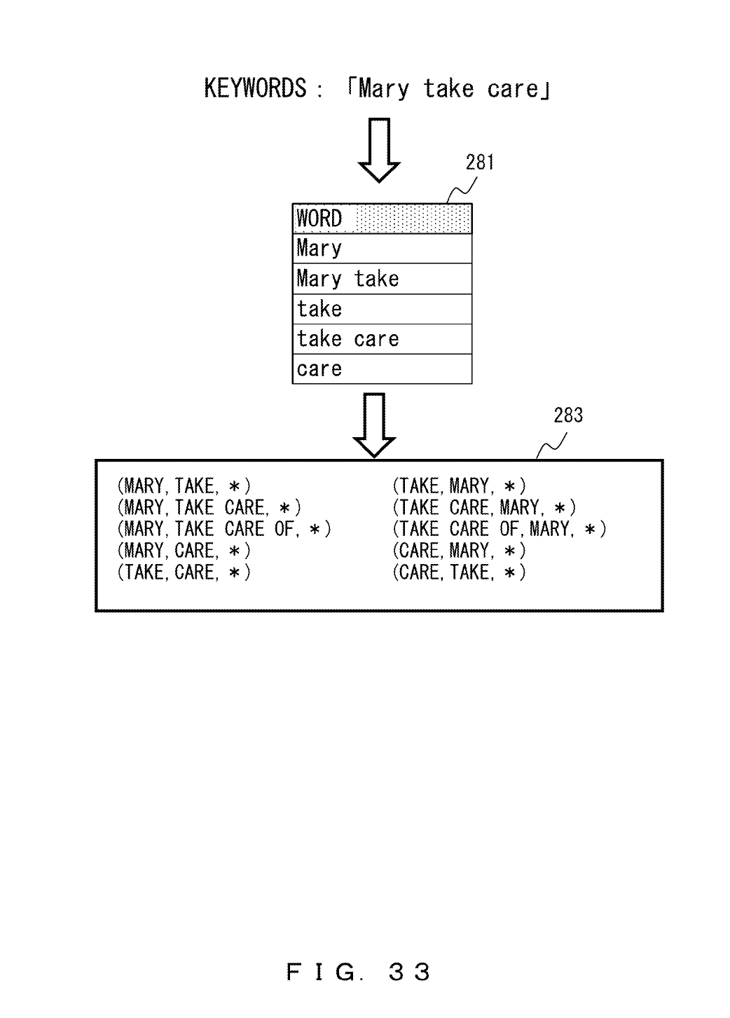

FIG. 33 illustrates a semantic analysis under a condition in which “Mary take care” is entered as the query 21. As depicted in FIG. 33, when the query input unit 23 determines that the query 21 is a keyword, the keyword input unit 25 divides the query 21 into words. In FIG. 33, the keyword input unit 25 expands “Mary take care” into the five elements, “Mary”, “Mary take”, “take”, “take care”, and “care”. The keyword converting unit 27 refers to the dictionary table 279 stored in the dictionary 51 for the words obtained via the expanding. As the dictionary table 279 does not include “Mary take”, the search-key generating unit 29 generates minimum semantic units, as indicated by search keys 283.

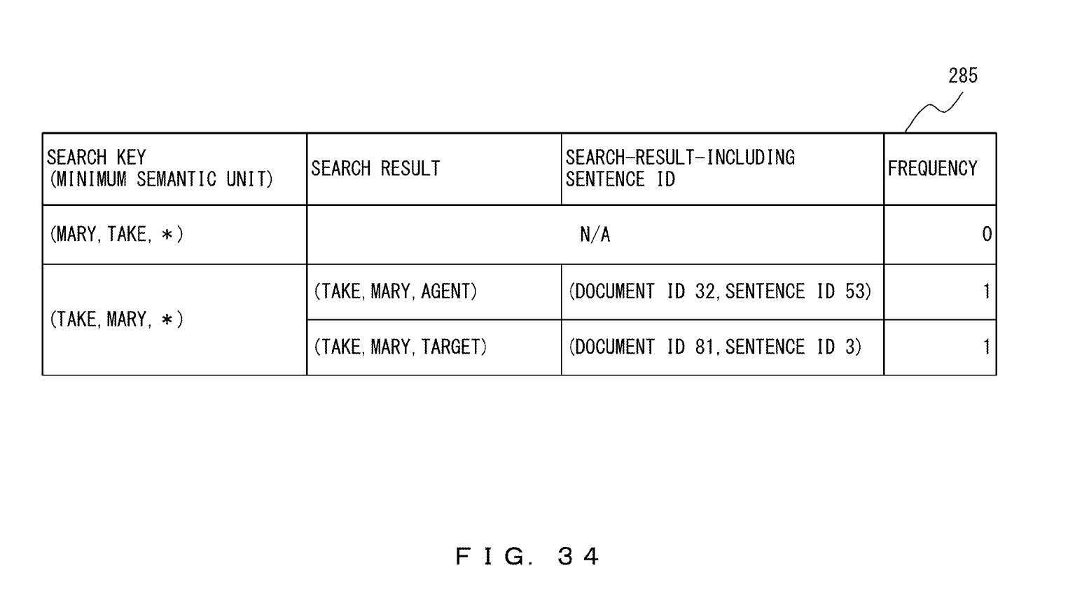

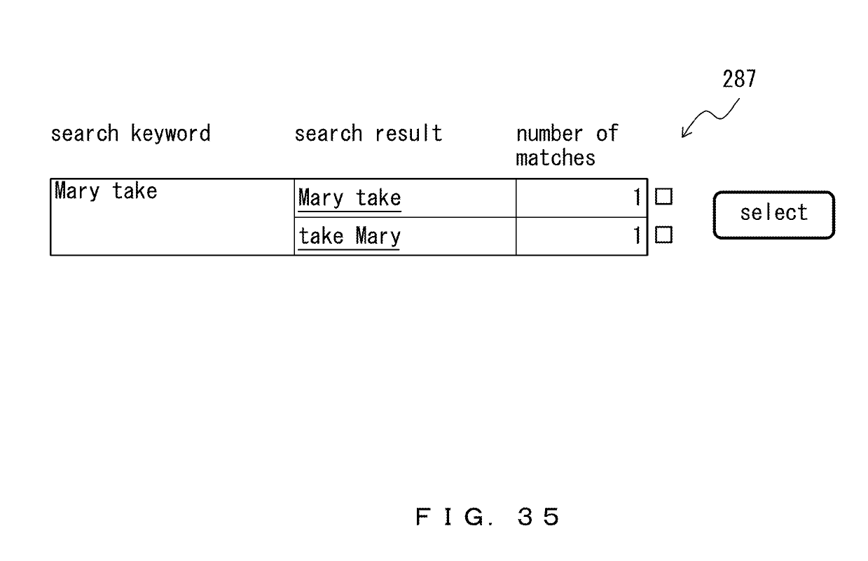

FIG. 34 illustrates an example of a search result 285. As depicted in FIG. 34, the search result 285 indicates a search result under a condition in which the query 21 is “Mary take”, i.e., a result of a search of the search-target-document DB 11 performed by the keyword search unit 45 for sentences corresponding to search keys 277. The search result 285 indicates that two sentences have been extracted. FIG. 35 illustrates an exemplary screen display 287. As depicted in FIG. 35, the exemplary screen display 287 displays a query 21, search results, and the numbers of matches and includes a button for narrowing-down.

As described above, the information search apparatus 1 in accordance with variation 2 is capable of searching for English documents using a query 21 that includes at least one English word. The information search apparatus 1 is capable of automatically determining which of an English sentence or word the query 21 is and making a search by performing a semantic analysis of the query 21, as in the case of a Japanese sentence. Hence, an increase in the number of keywords included in the query 21 or the inputting of a sentence does not make a user's intentions vague, so that a search result contrary to the user's intentions can be prevented from being incorporated. Simple examples have been cited in the embodiment, and an increased number of keywords can be addressed using the configuration and the algorithm.

The information search apparatus 1 may generate a search index 13 by performing a semantic analysis of an English document. In addition, as in the case of the information search apparatus 1 in accordance with the aforementioned embodiment, a table presented to a user as a search result may display search results sorted using evaluation values. This allows intended information to be retrieved more easily.

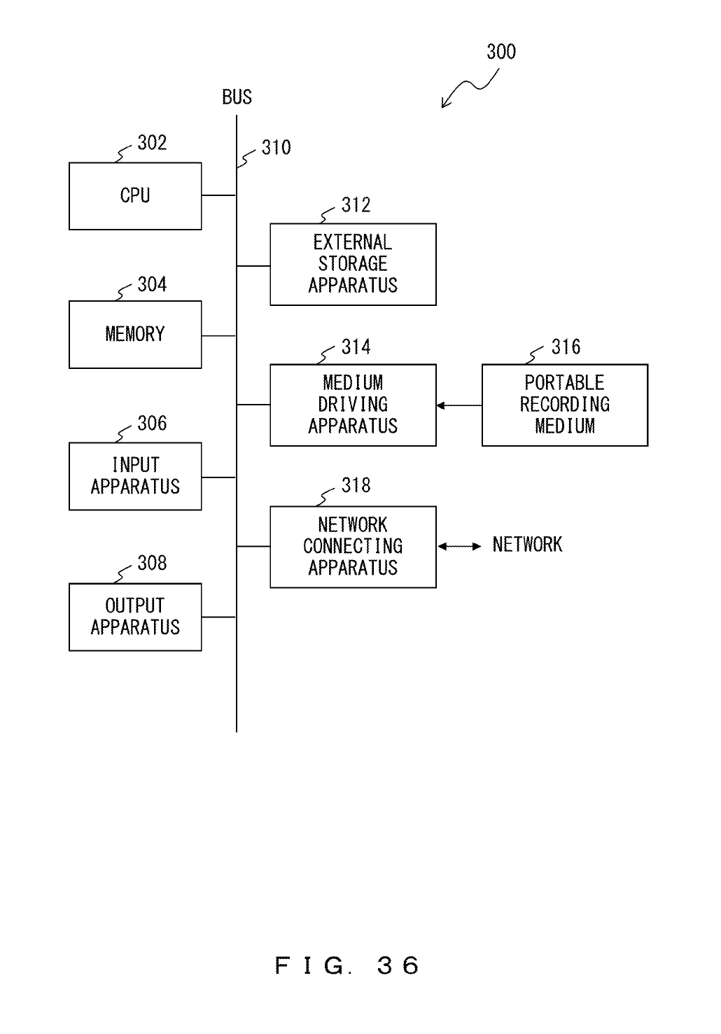

The following will describe an exemplary computer usable to cause a computer to perform the operations of the information search methods in accordance with the aforementioned embodiment and variations 1 and 2. FIG. 36 is a block diagram illustrating an exemplary hardware configuration of a standard computer. As depicted in FIG. 36, elements such as a central processing unit (CPU) 302, a memory 304, an input apparatus 306, an output apparatus 308, an external storage apparatus 312, a medium driving apparatus 314, and a network connecting apparatus are connected to a computer 300 via a bus 310.

The CPU 302 is an arithmetic processing unit that controls operations of the entirety of the computer 300. The memory 304 is a storage unit in which a program for controlling an operation of the computer 300 is stored in advance and which is used as a work area on an as-needed basis to execute a program. The memory 304 is, for example, a random access memory (RAM) or a read only memory (ROM). When a user of the computer operates the input apparatus 306, the input apparatus 306 obtains, from the user, inputs of various pieces of information associated with the operations and sends the obtained input information to the CPU 302. The input apparatus 306 is, for example, a keyboard apparatus or a mouse apparatus. The output apparatus 308, which outputs reprocessing results provided by the computer 300, includes, for example, a display apparatus. The display apparatus displays texts and images in accordance with display data sent by the CPU 302.

The external storage apparatus 312 is, for example, a hard disk. Obtained data, various control programs executed by the CPU 302, and so on are stored in the external storage apparatus 312. The medium driving apparatus 314 is used to write data to and read data from a portable recording medium 316. The CPU 302 may read a predetermined control program recorded in the portable recording medium 316 via the recording medium driving apparatus 314 so as to perform various controlling processes by executing the program. The portable recording medium 316 is, for example, a compact disc (CD)-ROM, a digital versatile disc (DVD), or a universal serial bus (USB) memory. A network connecting apparatus 318 is an interface apparatus that manages wire or wireless communications of various pieces of data performed with an outside element. The bus 310 is a communication path that connects, for example, the aforementioned apparatuses to each other and through which data is communicated.

A program for causing a computer to perform the information search methods in accordance with the aforementioned embodiment and variations 1 and 2 is stored in, for example, the external storage apparatus 312. The CPU 302 reads the program from the external storage apparatus 312 and causes the computer 300 to perform an operation for an information search. To achieve this, a control program for causing the CPU 302 to perform a process for an information search is created and stored in the external storage apparatus 312 in advance. A predetermined instruction from the input apparatus 306 is given to the CPU 302, causing the CPU 302 to execute the control program read from the external storage apparatus 312. The program may be stored in the portable recording medium 316.

The present invention is not limited to the aforementioned embodiments and may have various configurations or embodiments without departing from the spirit of the invention. For example, one or more computers may achieve the function of the information search apparatus 1. The described process flows are examples, and, as long as a processing result does not change, a change may be made to the flows.

The elements of the information search apparatus 1 may be functional modules achieved by a program executed on an APU. The functional blocks separated from each other in FIG. 1 are examples and thus may be different from those in the actual program module configuration. In addition, some of or all of the elements may be integrated to form an integrated circuit. The elements may be achieved as apparatuses that include at least some processes as dedicated modules.

Alternatively, the information search apparatus 1 may be achieved by, for example, a system connected via a network, wherein an input-output portion is provided on a client side of the system, and information is processed or used on a server side of the system. In addition, an apparatus that performs various processes and an apparatus that accumulates information may be provided separately from each other on a server side. The information search apparatus 1 may be, for example, a system that includes a plurality of information processing apparatuses each including some of the functions of the information search apparatus 1.

The search-target-document DB 11, the search index 13, and so on may, for example, be provided separately from a computer that performs search processes. An apparatus that generates the search-target-document DB 11 and the search index 13 may be provided separately from a search apparatus. In accordance with a configuration in which the components are provided separately from each other in such a manner, each apparatus can have a simple configuration.

The embodiment above were described with reference to an example in which an evaluation value is introduced for a query 21 that is a sentence, but, in the case of a keyword-based search, the evaluation value of a document may be calculated to rank the document.

In the aforementioned embodiment and variations 1 and 2, the query input unit 23 and the input apparatus 306 are examples of the input unit. The keyword input unit 25, the keyword converting unit 27, the search-key generating unit 29, the sentence-set input unit 31, the semantic analysis unit 33, the minimum-semantic-unit generating unit 35, the keyword search unit 45, the natural-sentence search unit 47, and the CPU 302 are examples of the processor or functions thereof. The storage unit 53, the external storage apparatus 312, and the portable recording medium 316 are examples of the storage unit. A minimum semantic unit is an example of semantic information.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. An information search apparatus comprising:
a processor configured to receive an input of information that includes a plurality of search words, to separate two search words from the information that includes a plurality of search words, to search for and extract, from a storage unit, two words that correspond to the two search words and semantic information of the two words, the storage unit storing a plurality of words included in a search target sentence and semantic information in association with the search target sentence, the semantic information stored in the storage unit indicating a relationship established within the search target sentence between the plurality of words and another word, and to output the extracted semantic information.

2. The information search apparatus according to claim 1, wherein
the semantic information includes semantic marks corresponding to the two words, and
the processor converts the separated search words into semantic marks, designates two of the semantic marks obtained via the conversion as search keys, and searches the storage unit for the semantic information that includes the search keys.

3. The information search apparatus according to claim 1, wherein
the processor converts the semantic information into a superficial character string and outputs the superficial character string.

4. The information search apparatus according to claim 1, wherein
the processor refers to an emergence position in the search target sentence stored in the storage unit in association with the semantic information, the emergence position being a position at which at least one of the two words included in the semantic information emerges, extracts at least a portion of the sentence according to the emergence position, and outputs the extracted portion of the search target.

5. The information search apparatus according to claim 4, wherein
the processor receives an instruction to narrow down the extracted semantic information, and outputs only the semantic information obtained as a result of the narrowing down that depends on the received instruction.

6. The information search apparatus according to claim 1, wherein
the processor receives an input of information that includes two search words or receives an input of at least one sentence, and
when the received input is the sentence, the processor generates semantic information by performing a semantic analysis of the sentence, and searches the storage unit for a sentence stored in association with the semantic information.

7. The information search apparatus according to claim 1, further comprising:
the storage unit configured to store the semantic information in association with a search target sentence, the semantic information indicating a plurality of words included in the search target sentence and a relationship established within the search target sentence between the plurality of words and another word, wherein
the processor stores in the storage unit the semantic information and the sentence in association with each other by performing a semantic analysis of an input sentence.

8. An information search method, comprising:
receiving an input of information that includes a plurality of search words;
separating two search words from the information that includes a plurality of search words;
searching for and extracting, from a storage unit, two words that correspond to the two search words and semantic information of the two words, the storage unit storing a plurality of words included in a search target sentence and semantic information in association with the search target sentence, the semantic information stored in the storage unit indicating a relationship established within the search target sentence between the plurality of words and another word; and
outputting the extracted semantic information.

9. The information search method according to claim 8, wherein
the semantic information includes semantic marks corresponding to the two words, and
the information search method further comprises:
converting the separated search words into semantic marks;
designating two of the semantic marks obtained via the conversion as search keys; and
searching the storage unit for the semantic information that includes the search keys.

10. The information search method according to claim 8, further comprising:
converting the semantic information into a superficial character string, and outputting the superficial character string.

11. The information search method according to claim 8, further comprising:
referring to an emergence position in the search target sentence stored in the storage unit in association with the semantic information, the emergence position being a position at which at least one of the two words included in the semantic information emerges;
extracting at least a portion of the sentence according to the emergence position; and
outputting the extracted portion of the search target.

12. The information search method according to claim 11, further comprising:
receiving an instruction to narrow down the extracted semantic information; and
outputting only the semantic information obtained as a result of the narrowing down that depends on the received instruction.

13. The information search method according to claim 8, further comprising:
receiving an input of information that includes two search words or receives an input of at least one sentence;
when the received input is the sentence, generating semantic information by performing a semantic analysis of the sentence; and
searching the storage unit for a sentence stored in association with the semantic information.

14. The information search method according to claim 8, further comprising:
performing a semantic analysis of an input sentence; and
storing semantic information in the storage unit in association with the sentence, the semantic information indicating a plurality of words included in the sentence and obtained from the semantic analysis, and indicating a relationship established within the sentence between the plurality of words and another word.
